(19) United States
(12) Patent Application Publication
(10) Pub. No.: US 2018/0176599 A1
(43) Pub. Date: Jun. 21, 2018

(54) MULTI-LAYER VIDEO ENCODING METHOD AND MULTI-LAYER VIDEO DECODING METHOD USING DEPTH BLOCK

(71) Applicant: SAMSUNG ELECTRONICS CO., LTD., Suwon-si (KR)

(72) Inventors: Min-woo PARK, Yongin-si (KR); Jin-young LEE, Suwon-si (KR)

(73) Assignee: SAMSUNG ELECTRONICS CO., LTD., Suwon-si (KR)

(21) Appl. No.: 15/126,032

(22) PCT Filed: Mar. 16, 2015
(86) PCT No.: PCT/KR2015/002541

§ 371 Date: Sep. 14, 2016

Related U.S. Application Data
(60) Provisional application No. 61/953,200, filed on Mar. 14, 2014.

(51) Int. Cl. H04N 19/597; H04N 19/119; H04N 19/182; H04N 19/176; H04N 19/187

(52) U.S. Cl. CPC H04N 19/597; H04N 19/119; H04N 19/187; H04N 19/176; H04N 19/182

(57) ABSTRACT

Provided is a multi-layer video decoding method. The multi-layer video decoding method includes determining a depth block corresponding to a current block; splitting the current block into two regions, based on sample values included in the determined depth block; and performing motion compensation by using the split two regions.

### TECHNICAL FIELD

The present disclosure relates to a multi-layer video encoding method and a multi-layer video decoding method.

### BACKGROUND ART

As hardware for reproducing and storing high resolution or high quality video content is being developed and supplied, the need for a video codec for effectively encoding or decoding the high resolution or high quality video content is increasing. According to a conventional video codec, a video is encoded according to a limited encoding method based on a macroblock having a predetermined size.

Image data of a spatial region is transformed into coefficients of a frequency region via frequency transformation. According to a video codec, an image is split into blocks having a predetermined size, discrete cosine transformation (DCT) is performed on each block, and frequency coefficients are encoded in block units, for rapid calculation of frequency transformation. Compared with image data of a spatial region, coefficients of a frequency region are easily compressed. In particular, since an image pixel value of a spatial region is expressed according to a prediction error via inter prediction or intra prediction of a video codec, when frequency transformation is performed on the prediction error, a large amount of data may be transformed to 0. According to a video codec, an amount of data may be reduced by replacing data that is consecutively and repeatedly generated with small-sized data.

A multi-layer video codec encodes and decodes a first layer video and at least one second layer video. Amounts of data of the first layer video and the second layer video may be reduced by removing temporal/spatial redundancy and layer redundancy of the first layer video and the second layer video.

### DETAILED DESCRIPTION OF THE INVENTION

### Technical Problem

The present disclosure provides efficient multi-layer video encoding and decoding methods using a depth block.

### Technical Solution

The present disclosure provides a multi-layer video decoding method including determining a depth block corresponding to a current block; splitting the current block into two regions, based on sample values included in the determined depth block; and performing motion compensation by using the split two regions.

### Advantageous Effects of the Invention

By using efficient multi-layer video encoding and decoding methods using a depth block, encoding/decoding efficiency may be improved.

### DESCRIPTION OF THE DRAWINGS

FIG. 1A is a block diagram of a multi-layer video encoding apparatus, according to an embodiment.

FIG. 1B is a flowchart of a multi-layer video encoding method, according to an embodiment.

FIG. 1C is a flowchart of a method of determining a partition mode of a current block and determining motion vectors based on the determined partition mode, according to an embodiment.

FIG. 2A is a block diagram of a multi-layer video decoding apparatus, according to an embodiment.

FIG. 2B is a flowchart of a multi-layer video decoding method, according to an embodiment.

FIG. 2C is a flowchart of a method of determining a partition mode of a current block and determining motion vectors based on the determined partition mode, the method being performed by the multi-layer video decoding apparatus, according to an embodiment.

FIG. 3A illustrates an inter-layer prediction structure, according to an embodiment.

FIG. 3B illustrates a multi-layer video, according to an embodiment.

FIG. 4 is a diagram for describing a method of determining a depth block corresponding to a current block, the method being performed by the multi-layer video decoding apparatus 20, according to an embodiment.

FIG. 5A is a diagram for describing a method of splitting a current block into two regions, the method being performed by the multi-layer video decoding apparatus 20, according to an embodiment.

FIG. 5B is a diagram illustrating a current block that is split into two regions, according to an embodiment.

FIG. 6A is a diagram for describing a method of determining a partition mode of a current block, the method being performed by the multi-layer video encoding apparatus 10, according to an embodiment.

FIG. 6B is a diagram for describing a method of determining motion vectors with respect to partitions of a current block, according to an embodiment.

FIG. 6C is a diagram for describing a method of determining motion vectors of partitions of a current block when a partition mode of the current block is PART_2N×N, according to an embodiment.

FIG. 7 is a diagram for describing a method of splitting a current block by using a depth block corresponding to the current block, according to an embodiment.

FIG. 8 is a block diagram of a video encoding apparatus based on coding units according to a tree structure, according to an embodiment.

FIG. 9 is a block diagram of a video decoding apparatus based on coding units according to a tree structure, according to an embodiment.

FIG. 10 is a diagram for describing a concept of coding units, according to an embodiment.

FIG. 11 is a block diagram of a video encoder based on coding units, according to an embodiment.

FIG. 12 is a block diagram of a video decoder based on coding units, according to an embodiment.

FIG. 13 is a diagram illustrating coding units and partitions, according to an embodiment.

FIG. 14 is a diagram for describing a relationship between a coding unit and transformation units, according to an embodiment.

FIG. 15 illustrates a plurality of pieces of encoding information, according to an embodiment.

FIG. 16 is a diagram of coding units, according to an embodiment.

FIGS. 17, 18, and 19 are diagrams for describing a relationship between coding units, prediction units, and transformation units, according to an embodiment.

FIG. 20 is a diagram for describing a relationship between a coding unit, a prediction unit, and a transformation unit, according to encoding mode information of Table 2.

FIG. 21 is a diagram of a physical structure of a disc in which a program is stored, according to an embodiment.

FIG. 22 is a diagram of a disc drive for recording and reading a program by using the disc.

FIG. 23 is a diagram of an overall structure of a content supply system for providing a content distribution service.

FIGS. 24 and 25 are diagrams respectively of an external structure and an internal structure of a mobile phone to which a video encoding method and video decoding method of the present disclosure are applied, according to an embodiment.

FIG. 26 is a diagram of a digital broadcasting system to which a communication system according to the present disclosure is applied.

FIG. 27 illustrates a network structure of a cloud computing system using a video encoding apparatus and a video decoding apparatus according to an embodiment.

### BEST MODE

According to an aspect of the present disclosure, there is provided a multi-layer video decoding method including determining a depth block corresponding to a current block; splitting the current block into two regions, based on sample values included in the determined depth block; and performing motion compensation by using the split two regions.

The splitting of the current block into the two regions, based on the sample values included in the determined depth block may include determining an average value of corner pixels of the depth block as a threshold value; splitting the depth block into a first region and a second region, wherein the first region includes samples of which sample values are each greater than the threshold value and the second region includes samples of which sample values are each equal to or less than the threshold value; and splitting the current block, based on split shapes of the first region and the second region.

The multi-layer video decoding method may further include determining a partition mode of the current block as one of a PART_2N×N mode and a PART_N×2N mode; and determining motion vectors with respect to partitions of the current block, respectively, based on the determined partition mode of the current block.

The corner pixels may include one or more of a top-left pixel, a bottom-left pixel, a top-right pixel, and a bottom-right pixel in the depth block.

The motion vectors may be determined based on motion vectors used in the motion compensation.

According to another aspect of the present disclosure, there is provided a multi-layer video encoding method including determining a depth block corresponding to a current block; splitting the current block into two regions, based on sample values included in the determined depth block; and performing motion compensation by using the split two regions.

The splitting of the current block into the two regions, based on the sample values included in the determined depth block, may include determining an average value of corner pixels of the depth block as a threshold value; splitting the depth block into a first region and a second region, wherein the first region includes samples of which sample values are each greater than the threshold value and the second region includes samples of which sample values are each equal to or less than the threshold value; and splitting the current block, based on split shapes of the first region and the second region.

The multi-layer video encoding method may further include determining a partition mode of the current block as one of a predetermined number of partition modes, based on the sample values included in the determined depth block; and determining motion vectors with respect to partitions of the current block, based on the determined partition mode of the current block, wherein the motion vectors are determined based on motion vectors used in the motion compensation.

The corner pixels may include one or more of a top-left pixel, a bottom-left pixel, a top-right pixel, and a bottom-right pixel in the depth block.

The predetermined number of partition modes may include two partition modes that are a PART_N×2N mode and a PART_2N×N mode.

According to another aspect of the present disclosure, there is provided a multi-layer video decoding apparatus including a decoder configured to determine a depth block corresponding to a current block, to split the current block into two regions, based on sample values included in the determined depth block, and to perform motion compensation by using the split two regions.

The decoder may be further configured to determine an average value of corner pixels of the depth block as a threshold value, to split the depth block into a first region and a second region, wherein the first region includes samples of which sample values are each greater than the threshold value and the second region includes samples of which sample values are each equal to or less than the threshold value; and to split the current block, based on split shapes of the first region and the second region.

According to another aspect of the present disclosure, there is provided a multi-layer video encoding apparatus including an encoder configured to determine a depth block corresponding to a current block, to split the current block into two regions, based on sample values included in the determined depth block, and to perform motion compensation by using the split two regions.

The encoder may be further configured to determine an average value of corner pixels of the depth block as a threshold value, to split the depth block into a first region and a second region, wherein the first region includes samples of which sample values are each greater than the threshold value and the second region includes samples of which sample values are each equal to or less than the threshold value, and to split the current block, based on split shapes of the first region and the second region.

### MODE OF THE INVENTION

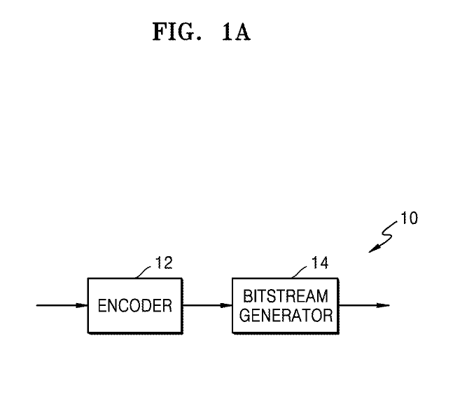

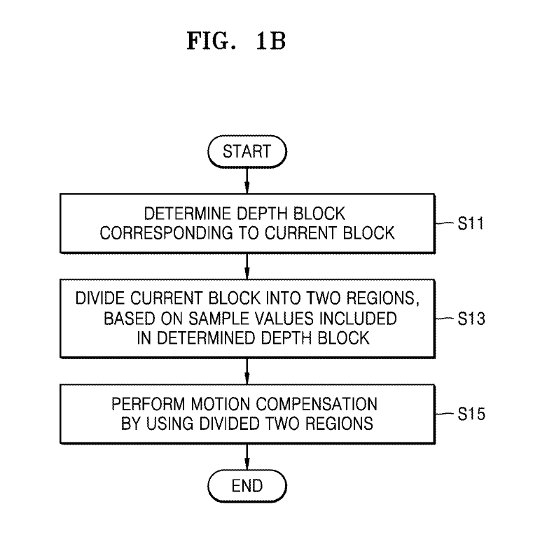

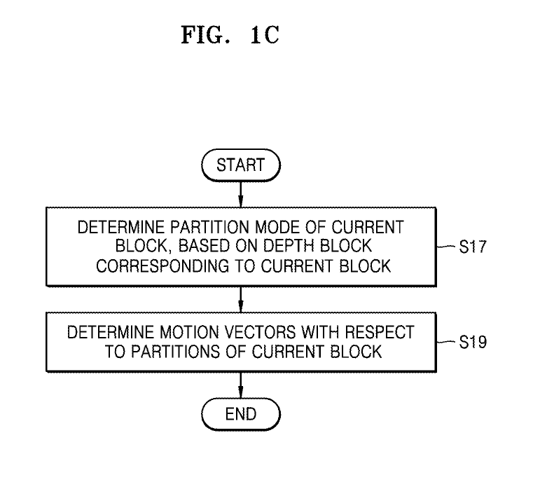

Hereinafter, with reference to FIGS. 1A through 7, a multi-layer video encoding technique and multi-layer video decoding technique using a depth block according to an embodiment will now be provided.

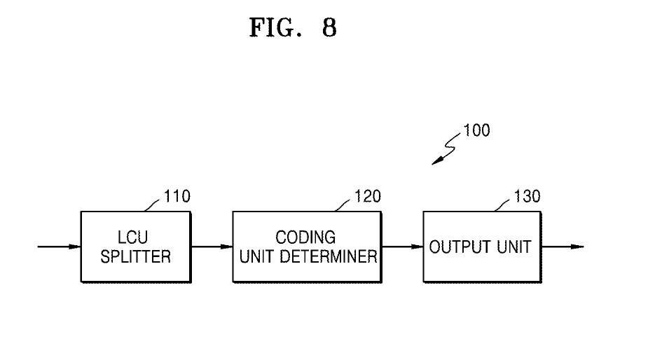

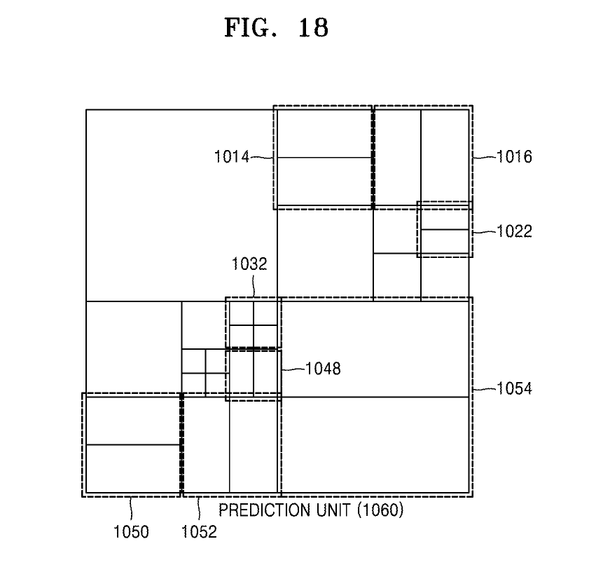

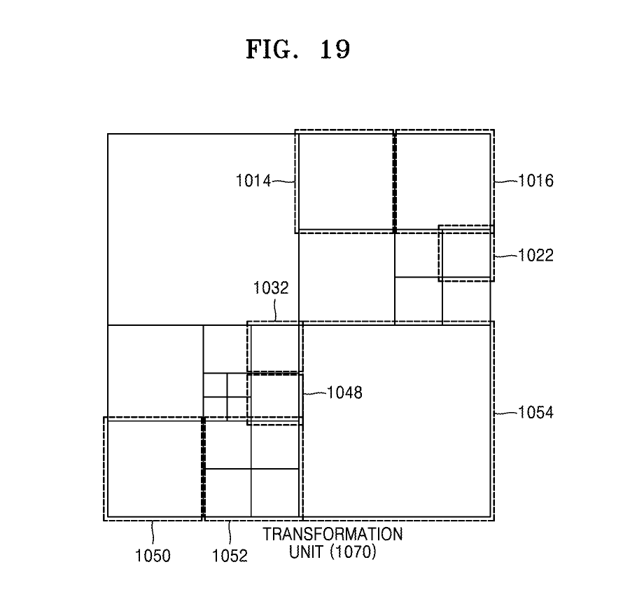

Also, with reference to FIGS. 8 through 20, a video encoding technique and video decoding technique according to an embodiment, which are based on coding units having a tree structure and are applicable to the multi-layer video encoding and decoding techniques, will be described.

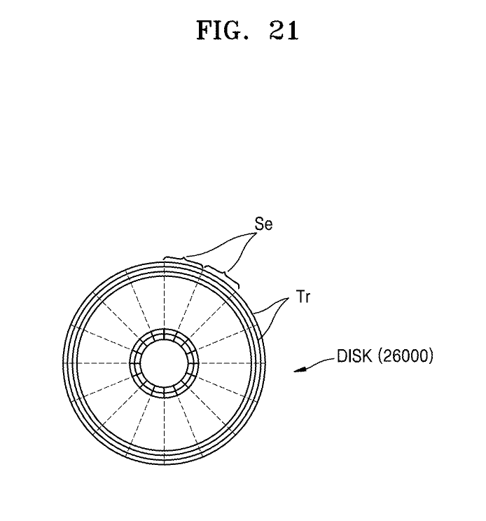

Also, with reference to FIGS. 21 through 27, embodiments to which the video encoding method and the video decoding method are applicable will be described.

Hereinafter, an ‘image’ may refer to a still image or a moving image of a video, or a video itself.

Hereinafter, a ‘sample’ refers to data that is assigned to a sampling location of an image and is to be processed. For example, pixel values or residual of a block of an image in a spatial domain may be samples.

Hereinafter, a ‘current block’ may refer to a block of an image to be encoded or decoded.

Hereinafter, a ‘neighboring block’ refers to at least one encoded or decoded block adjacent to the current block. For example, a neighboring block may be located at the top, upper right, left, or upper left of the current block. Also, a neighboring block may be a spatially-neighboring block or a temporally-neighboring block. For example, the temporally-neighboring block may include a block of a reference picture, which is co-located as a current block, or a neighboring block of the co-located block.

Hereinafter, a “layer image” refers to specific-view images or specific-type images. In a multiview video, one layer image indicates color images or depth images which are input at a specific view. For example, in a three-dimensional (3D) video, each of a left-view texture image, a right-view texture image, and a depth image forms one layer image. The left-view texture image may form a first layer image, the right-view texture image may form a second layer image, and the depth image may form a third layer image.

FIG. 1A is a block diagram of a multi-layer video encoding apparatus, according to an embodiment.

Referring to FIG. 1A, a video encoding apparatus 10 may include an encoder 12 and a bitstream generator 14.

The video encoding apparatus 10 according to an embodiment may classify a plurality of image sequences according to layers and may encode each of the image sequences according to a scalable video coding scheme, and may output separate streams including data encoded according to layers. The video encoding apparatus 10 may encode a first layer image sequence and a second layer image sequence to different layers.

For example, the encoder 12 may encode first layer images and may output a first layer stream including encoding data of the first layer images. In addition, the encoder 12 may encode second layer images and may output a second layer stream including encoding data of the second layer images.

For example, according to a scalable video coding method based on spatial scalability, low resolution images may be encoded as first layer images, and high resolution images may be encoded as second layer images. An encoding result of the first layer images may be output as a first layer stream, and an encoding result of the second layer images may be output as a second layer stream.

The video encoding apparatus 10 according to an embodiment may express and encode the first layer stream and the second layer stream as one bitstream through a multiplexer.

As another example, a multiview video may be encoded according to a scalable video coding scheme. Left-view images may be encoded as first layer images and right-view images may be encoded as second layer images. Alternatively, central-view images, left-view images, and right-view images may be each encoded, wherein the central-view images are encoded as first layer images, the left-view images are encoded as second layer images, and the right-view images are encoded as third layer images. Alternatively, a central-view texture image, a central-view depth image, a left-view texture image, a left-view depth image, a right-view texture image, and a right-view depth image may be respectively encoded as a first layer image, a second layer image, a third layer image, a fourth layer image, a fifth layer image, and a sixth layer image.

As another example, a central-view texture image, a central-view depth image, a left-view depth image, a left-view texture image, a right-view depth image, and a right-view texture image may be respectively encoded as a first layer image, a second layer image, a third layer image, a fourth layer image, a fifth layer image, and a sixth layer image.

As another example, a scalable video coding method may be performed according to temporal hierarchical prediction based on temporal scalability. A first layer stream including encoding information generated by encoding base frame rate images may be output. Temporal levels may be classified according to frame rates and each temporal level may be encoded according to layers. A second layer stream including encoding information of a high frame rate may be output by further encoding higher frame rate images by referring to the base frame rate images.

Also, scalable video coding may be performed on a first layer and a plurality of extension layers (a second layer, a third layer, . . . , a K-th layer). When there are at least three extension layers, first layer images and K-th layer images may be encoded. Accordingly, an encoding result of the first layer images may be output as a first layer stream, and encoding results of the first, second, . . . , K-th layer images may be respectively output as first, second, . . . , K-th layer streams.

The video encoding apparatus 10 according to an embodiment may perform inter prediction in which images of a single layer are referenced in order to predict a current image. By performing inter prediction, a motion vector between the current image and a reference image may be derived, and a residual component that is a difference component between the current image and a prediction image generated by using the reference image may be generated.

Also, when the video encoding apparatus 10 according to an embodiment allows at least three layers, i.e., first, second, and third layers, inter-layer prediction between a first layer image and a third layer image, and inter-layer prediction between a second layer image and a third layer image may be performed according to a multilayer prediction structure.

In interlayer prediction, when a layer of a current image and a layer of a reference image are different from each other in their views, a disparity vector between the current image and the reference image of the layer different from that of the current image may be derived, and a residual component that is a difference component between the current image and a prediction image generated by using the reference image of the different layer may be generated.

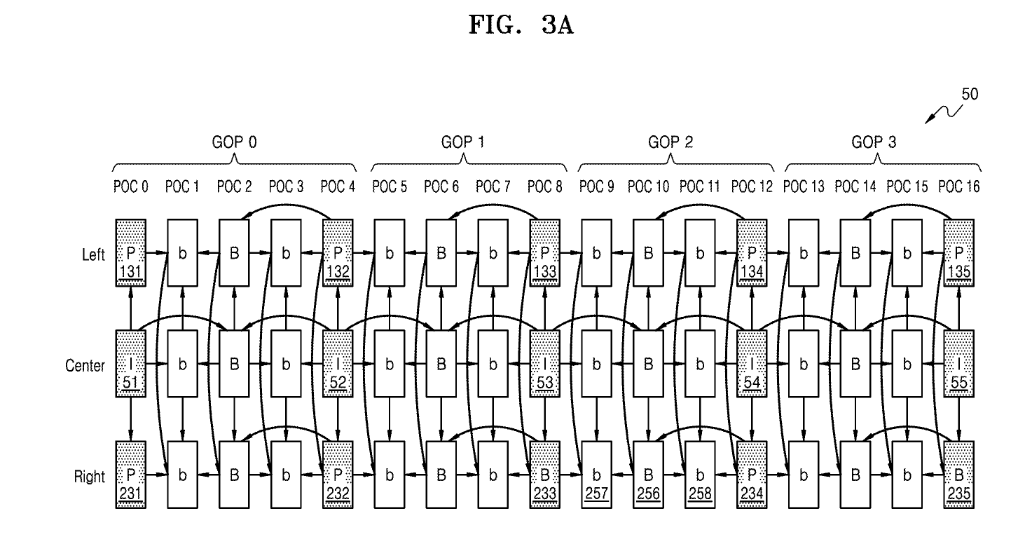

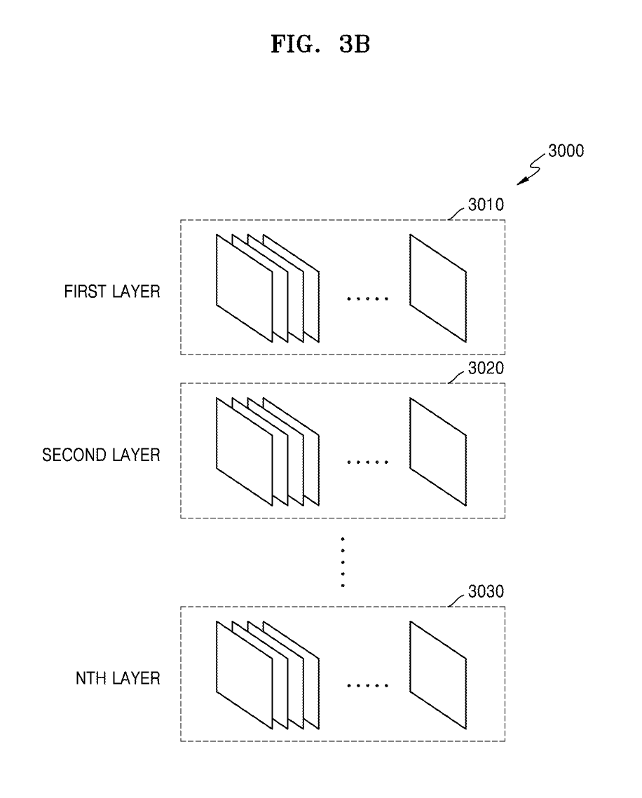

An inter-layer prediction structure will be described below with reference to FIG. 3A.

The video encoding apparatus 10 according to an embodiment may perform encoding according to blocks of each image of a video, according to layers. A block may have a square shape, a rectangular shape, or an arbitrary geometrical shape, and is not limited to a data unit having a predetermined size. The block may be a largest coding unit, a coding unit, a prediction unit, or a transformation unit, among coding units according to a tree structure. The largest coding unit including coding units of a tree structure may be called differently, such as a coding tree unit, a coding block tree, a block tree, a root block tree, a coding tree, a coding root, or a tree trunk. Video encoding and decoding methods based on coding units according to a tree structure will be described below with reference to FIGS. 8 through 20.

Inter prediction and inter-layer prediction may be performed based on a data unit, such as a coding unit, a prediction unit, or a transformation unit.

The encoder 12 according to an embodiment may generate symbol data by performing source coding operations including inter prediction or intra prediction on first layer images. Symbol data indicates a value of each encoding parameter and a sample value of a residual.

For example, the encoder 12 may generate symbol data by performing inter or intra prediction, transformation, and quantization on samples on samples of a data unit of first layer images, and may generate a first layer stream by performing entropy encoding on the symbol data.

The encoder 12 may encode second layer images based on coding units of a tree structure. The encoder 12 may generate symbol data by performing inter/intra prediction, transformation, and quantization on samples of a coding unit of second layer images, and may generate a second layer stream by performing entropy encoding on the symbol data.

The encoder 12 according to an embodiment may perform inter-layer prediction in which a second layer image is predicted by using prediction information of a first layer image. In order to encode a second layer original image from a second layer image sequence through an inter-layer prediction structure, the encoder 12 may determine motion information of a second layer current image by using motion information of a first layer reconstructed image, and may encode a prediction error between the second layer original image and a second layer prediction image by generating the second layer prediction image based on the determined motion information.

The encoder 12 may perform inter-layer prediction on the second layer image according to coding units or prediction units, and then may determine a block of the first layer image which is to be referred to by a block of the second layer image. For example, a reconstructed block of the first layer image of which location corresponds to a location of a current block of the second layer image may be determined. The encoder 12 may use, as a second layer prediction block, the reconstructed first layer block that corresponds to the second layer block. In this regard, the encoder 12 may determine the second layer prediction block by using the reconstructed first layer block that is co-located with the second layer block.

According to the inter-layer prediction structure, the encoder 12 may use the second layer prediction block as a reference image for inter-layer prediction with respect to a second layer original block, wherein the second layer prediction block is determined by using the reconstructed first layer block. The encoder 12 may perform entropy encoding by transforming and quantizing an error, i.e., a residual component according to inter-layer prediction, between a sample value of the second layer prediction block and a sample value of the second layer original block, by using the reconstructed first layer image.

The video encoding apparatus 10 may split a current block into a plurality of regions by using a depth block corresponding to the current block, and may encode the current block, based on the plurality of split regions.

The encoder 12 may determine the depth block that corresponds to the current block.

For example, the encoder 12 may obtain a disparity vector of the current block from a neighboring block, and may determine the depth block corresponding to the current block, based on the obtained disparity vector.

For example, the encoder 12 may determine the depth block corresponding to the current block, wherein the depth block is indicated by the disparity vector of the current block at a location of the current block.

The encoder 12 may split the depth block corresponding to the current block into a plurality of regions, and may split the current block into the plurality of regions, based on the plurality of split regions of the depth block.

The encoder 12 may determine a threshold value so as to split the depth block into the plurality of regions. The threshold value refers to a reference value with respect to the split when the depth block is split into the plurality of regions.

The encoder 12 may determine the threshold value by using sample values of the depth value. For example, the encoder 12 may determine the threshold value by using one or more corner samples included in the depth block. The corner samples may refer to a top-left sample, a bottom-left sample, a top-right sample, and a bottom-right sample in the depth block. The encoder 12 may determine, as the threshold value, an average value of sample values of the top-left sample, the bottom-left sample, the top-right sample, and the bottom-right sample in the depth block.

The encoder 12 may split the depth block into the plurality of regions by using the determined threshold value.

For example, the encoder 12 may split the depth block into a first region and a second region, wherein the first region is a region of samples having sample values greater than the threshold value, and the second region is a region of samples having sample values equal to or less than the threshold value.

The encoder 12 may split the current block into the plurality of regions, based on the plurality of split regions of the depth block that corresponds to the current block. For example, when the depth block corresponding to the current block is split into the first region and the second region, the encoder 12 may split the current block into two regions by matching the first region and the second region with the current block.

The encoder 12 may perform motion compensation on the current block by using the plurality of split regions.

For example, the encoder 12 may determine motion vectors respectively for the split two regions of the current block. Then, the encoder 12 may determine respective reference blocks of the respective two regions by using the determined motion vectors, may perform motion compensation on the two regions by using the reference blocks, respectively, and thus may encode the current block.

The encoder 12 may perform inter-layer prediction on the current block by using the plurality of split regions. For example, the encoder 12 may determine disparity vectors respectively for the split two regions of the current block. Then, the encoder 12 may determine respective reference blocks of the respective two regions by using the determined disparity vectors, may perform inter-layer prediction on the two regions by using the reference blocks, respectively, and thus may encode the current block.

The encoder 12 may perform intra prediction on the current block by using the plurality of split regions. For example, the encoder 12 may perform intra prediction on each of the split two regions of the current block.

The encoder 12 may perform a combination of at least two predictions of intra prediction, inter prediction, and inter-layer prediction on the plurality of split regions. For example, the encoder 12 may perform inter prediction on the first region of the split two regions, and may perform inter-layer prediction on the second region. In addition, the encoder 12 may perform inter-layer prediction on the first region of the split two regions, and may perform intra prediction on the second region.

The bitstream generator 14 may generate, in a bitstream, a plurality of pieces of data that are generated as an encoding result.

Hereinafter, operations of the video encoding apparatus 10 which are for inter-layer prediction are described in detail with reference to FIGS. 1B and 1C.

FIG. 1B is a flowchart of a multi-layer video encoding method, according to an embodiment.

In operation S11, the multi-layer video encoding apparatus 10 may determine a depth block that corresponds to a current block.

According to various embodiment of the present disclosure, the multi-layer video encoding apparatus 10 may obtain a disparity vector of the current block.

The multi-layer video encoding apparatus 10 may obtain the disparity vector of the current block from a neighboring block of the current block.

For example, the multi-layer video encoding apparatus 10 may obtain a disparity vector equal to a disparity vector of the neighboring block of the current block, as the disparity vector of the current block.

In addition, the multi-layer video encoding apparatus 10 may derive the disparity vector of the current block by using the disparity vector of the neighboring block.

For example, the multi-layer video encoding apparatus 10 may derive the disparity vector of the current block by applying a camera parameter to the disparity vector of the neighboring block.

In addition, the multi-layer video encoding apparatus 10 may derive the disparity vector of the current block by applying a camera parameter to predetermined sample values included in a block indicated by the disparity vector of the neighboring block.

The aforementioned method is exemplary, and the multi-layer video encoding apparatus 10 may obtain the disparity vector of the current block by using various methods not limited to the aforementioned method.

The multi-layer video encoding apparatus 10 may determine the depth block corresponding to the current block by using the disparity vector of the current block.

For example, the multi-layer video encoding apparatus 10 may determine, as the depth block corresponding to the current block, a depth block indicated by the disparity vector of the current block at a location of the current block.

The multi-layer video encoding apparatus 10 may determine the depth block corresponding to the current block in a depth image corresponding to a view equal to that of the current image. Alternatively, the multi-layer video encoding apparatus 10 may determine the depth block corresponding to the current block in a depth image corresponding to a view different from that of the current image.

For example, when a current image including the current block is a left-view texture image, the multi-layer video encoding apparatus 10 may determine the depth block corresponding to the current block in a left-view depth image.

When the current image including the current block is the left-view texture image, the multi-layer video encoding apparatus 10 may determine the depth block corresponding to the current block in a right-view depth image.

In operation S13, the multi-layer video encoding apparatus 10 may split the current block into two regions, based on sample values included in the determined depth block.

The multi-layer video encoding apparatus 10 may split the depth block corresponding to the current block into a plurality of regions, and may split the current block into a plurality of regions, based on the plurality of split regions of the depth block.

In order to split the current block into the plurality of regions, the multi-layer video encoding apparatus 10 may split the depth block corresponding to the current block into the plurality of regions.

The multi-layer video encoding apparatus 10 may determine a threshold value so as to split the depth block into the plurality of regions. The threshold value refers to a reference value with respect to the split when the depth block is split into the plurality of regions.

The multi-layer video encoding apparatus 10 may determine the threshold value by using the sample values of the depth block. For example, the multi-layer video encoding apparatus 10 may determine the threshold value as an average value of the sample values included in the depth block.

The multi-layer video encoding apparatus 10 may determine the threshold value by using one or more corner samples included in the depth block. The corner samples may refer to a top-left sample, a bottom-left sample, a top-right sample, and a bottom-right sample in the depth block.

For example, the multi-layer video encoding apparatus 10 may determine, as the threshold value, an average value of sample values of the top-left sample and the bottom-left sample in the depth block. Alternatively, the multi-layer video encoding apparatus 10 may determine, as the threshold value, an average value of sample values of the top-left sample, the bottom-left sample, the top-right sample, and the bottom-right sample in the depth block.

TH=(a+b+c+d)>>2 (1)

TH=(a+b+c+d+e)>>2 (2)

The multi-layer video encoding apparatus 10 may determine the threshold value by using Equation (1). a refers to a top-left sample value in the depth block, b refers to a top-right sample value in the depth block, c refers to a bottom-left sample value in the depth block, d refers to a bottom-right sample value in the depth block, and TH refers to the threshold value.

The multi-layer video encoding apparatus 10 may obtain the threshold value by rightward shifting a total sum of the top-left sample value, the bottom-left sample value, the top-right sample value, and the bottom-right sample value by 2 bits by using Equation (1).

The multi-layer video encoding apparatus 10 may obtain, as the threshold value, the average value of the sample values of the top-left sample, the bottom-left sample, the top-right sample, and the bottom-right sample in the depth block by using Equation (1).

The multi-layer video encoding apparatus 10 may determine the threshold value by using Equation (2). e refers to a compensation value. The multi-layer video encoding apparatus 10 may obtain the threshold value by rightward shifting a total sum of the top-left sample value, the bottom-left sample value, the top-right sample value, the bottom-right sample value, and the compensation value by 2 bits. e, as the compensation value, may refer to a rounding offset value. The rounding offset value refers to a coefficient capable of determining a rounding degree when the average value of the sample values of the top-left sample, the bottom-left sample, the top-right sample, and the bottom-right sample is calculated.

The multi-layer video encoding apparatus 10 may split the depth block into the plurality of regions by using the determined threshold value.

For example, the multi-layer video encoding apparatus 10 may split the depth block into a first region and a second region, wherein the first region is a region of samples having sample values equal to or greater than the threshold value, and the second region is a region of samples having sample values less than the threshold value. Alternatively, the multi-layer video encoding apparatus 10 may split the depth block into a first region and a second region, wherein the first region is a region of samples having sample values greater than the threshold value, and the second region is a region of samples having sample values equal to or less than the threshold value.

According to various embodiments of the present disclosure, each of the plurality of split regions of the depth block may have a random shape. For example, when the sample values in the depth block are asymmetrically distributed in the depth block, each of the split regions of the depth block may have the random shape.

The multi-layer video encoding apparatus 10 may split the current block into a plurality of regions, based on a division shape of the depth block corresponding to the current block. For example, when the depth block corresponding to the current block is split into a first region and a second region, the multi-layer video encoding apparatus 10 may split the current block into two regions by matching the first region and the second region with the current block.

For example, the multi-layer video encoding apparatus 10 may split the current block into a region of samples of the current block, the samples corresponding to locations of samples included in the first region of the depth block, and a region of samples of the current block, the samples corresponding to locations of samples included in the second region of the depth block.

Also, the multi-layer video encoding apparatus 10 may split the current block into two regions by matching boundaries of the first and second regions of the depth block with the current block.

Also, the multi-layer video encoding apparatus 10 may generate a division map by using the first and second regions of the depth block, and may split the current block into two regions by matching the generated division map with the current block.

According to various embodiments of the present disclosure, each of the plurality of split regions of the current block may have a random shape. For example, when the sample values in the depth block are asymmetrically distributed in the depth block, each of the split regions of the depth block may have the random shape, and the multi-layer video encoding apparatus 10 may split the current block into a plurality of regions that each have a random shape by matching the plurality of split regions of the depth block with the current block.

In operation S15, the multi-layer video encoding apparatus 10 may perform motion compensation by using the split two regions.

The multi-layer video encoding apparatus 10 may perform motion compensation on the current block by using the plurality of split regions.

For example, the multi-layer video encoding apparatus 10 may determine motion vectors respectively for the split two regions of the current block. Then, the multi-layer video encoding apparatus 10 may determine respective reference blocks of the respective two regions by using the determined motion vectors, may perform motion compensation on the two regions by using the reference blocks, respectively, and thus may encode the current block.

The multi-layer video encoding apparatus 10 may perform inter-layer prediction on the current block by using the plurality of split regions. For example, the multi-layer video encoding apparatus 10 may determine disparity vectors respectively for the split two regions of the current block. Then, the multi-layer video encoding apparatus 10 may determine respective reference blocks of the respective two regions by using the determined disparity vectors, may perform inter-layer prediction on the two regions by using the reference blocks, respectively, and thus may encode the current block.

The multi-layer video encoding apparatus 10 may perform intra prediction on the current block by using the plurality of split regions. For example, the multi-layer video encoding apparatus 10 may perform intra prediction on each of the split two regions of the current block.

The multi-layer video encoding apparatus 10 may perform a combination of at least two predictions of intra prediction, inter prediction, and inter-layer prediction on the plurality of split regions. For example, the multi-layer video encoding apparatus 10 may perform inter prediction on the first region of the split two regions, and may perform inter-layer prediction on the second region. In addition, the multi-layer video encoding apparatus 10 may perform inter-layer prediction on the first region of the split two regions, and may perform intra prediction on the second region.

FIG. 1C is a flowchart of a method of determining a partition mode of a current block and determining motion vectors based on the determined partition mode, the method being performed by the multi-layer video encoding apparatus 10, according to an embodiment.

In operation S17, the multi-layer video encoding apparatus 10 may determine the partition mode of the current block, based on a depth block corresponding to the current block.

The multi-layer video encoding apparatus 10 may determine the partition mode of the current block, based on the depth block corresponding to the current block. For example, the multi-layer video encoding apparatus 10 may determine the partition mode of the current block, based on sample values in the depth block corresponding to the current block.

When the multi-layer video encoding apparatus 10 determines the partition mode of the current block, the multi-layer video encoding apparatus 10 may determine the partition mode as one of limited partition modes. For example, the multi-layer video encoding apparatus 10 may determine the partition mode of the current block as one of PART_2N×N and PART_N×2N.

The multi-layer video encoding apparatus 10 may determine the partition mode as one of the limited partition modes by using the sample values of the depth block corresponding to the current block. For example, the multi-layer video encoding apparatus 10 may determine the partition mode of the current block as one of PART_2N×N and PART_N×2N by using at least one sample of corner samples of the depth block corresponding to the current block.

For example, when an absolute value of (a top-left sample value—a top-right sample value) in the depth block corresponding to the current block exceeds an absolute value of (the top-left sample value—a bottom-left sample value), the multi-layer video encoding apparatus 10 may determine the partition mode of the current block as PART_N×2N. When the absolute value of (the top-left sample value—the top-right sample value) in the depth block corresponding to the current block is equal to or less than the absolute value of (the top-left sample value—the bottom-left sample value), the multi-layer video encoding apparatus 10 may determine the partition mode of the current block as PART_2N×N.

As another example, when the top-left sample value of the depth block corresponding to the current block is less than a bottom-right sample value and a top-right sample value is less than the bottom-left sample value, and when the top-left sample value is equal to or greater than the bottom-right sample value and the top-right sample value is equal to or greater than the bottom-left sample value, the multi-layer video encoding apparatus 10 may determine the partition mode of the current block as PART_2N×N, otherwise, the multi-layer video encoding apparatus 10 may determine the partition mode of the current block as PART_N×2N.

In operation S19, the multi-layer video encoding apparatus 10 may determine motion vectors with respect to partitions of the current block.

The multi-layer video encoding apparatus 10 may obtain the motion vector and/or the disparity vector which is used in encoding and is with respect to each of the plurality of regions of the current block split in the operation S13.

The multi-layer video encoding apparatus 10 may determine a motion vector and/or a disparity vector of each of the partitions of the determined partition mode, by using the obtained motion vector and/or the obtained disparity vector.

For example, when the multi-layer video encoding apparatus 10 determines the partition mode of the current block as PART_2N×N, the multi-layer video encoding apparatus 10 may determine, as a motion vector of a top partition of the current block, a motion vector of a first region from among the plurality of split regions of the current block, the first region including the top-left sample, and may determine a motion vector of a second region of the current block as a motion vector of a bottom partition of the current block.

As another example, when the multi-layer video encoding apparatus 10 determines the partition mode of the current block as PART_2N×N, the multi-layer video encoding apparatus 10 may determine, as the motion vector of the bottom partition, the motion vector of the first region from among the plurality of split regions of the current block, the first region including the top-left sample, and may determine the motion vector of the second region of the current block as the motion vector of the top partition.

As another example, when the multi-layer video encoding apparatus 10 determines the partition mode of the current block as PART_N×2N, the multi-layer video encoding apparatus 10 may determine, as a motion vector of a left partition of the current block, the motion vector of the first region of the current block, the first region including the top-left sample, and may determine the motion vector of the second region of the current block as a motion vector of a right partition of the current block.

As another example, when the multi-layer video encoding apparatus 10 determines the partition mode of the current block as PART_N×2N, the multi-layer video encoding apparatus 10 may determine, as the motion vector of the right partition, the motion vector of the first region from among the plurality of split regions of the current block, the first region including the top-left sample, and may determine the motion vector of the second region of the current block as a motion vector of a left partition of the current block.

The aforementioned descriptions are exemplary, and the multi-layer video encoding apparatus 10 may determine the motion vector and/or the disparity vector of each of the partitions of the determined partition mode by using a motion vector and/or a disparity vector of each of the plurality of split regions of the current block, according to various methods.

The multi-layer video encoding apparatus 10 may store the determined motion vectors based on the partition mode of the current block. For example, when the partition mode of the current block corresponds to PART_N×2N, the multi-layer video encoding apparatus 10 may store the motion vector of the left partition and the motion vector of the right partition of the current block. The multi-layer video encoding apparatus 10 may encode, by using the stored motion vectors, blocks that are to be encoded after the current block in encoding order.

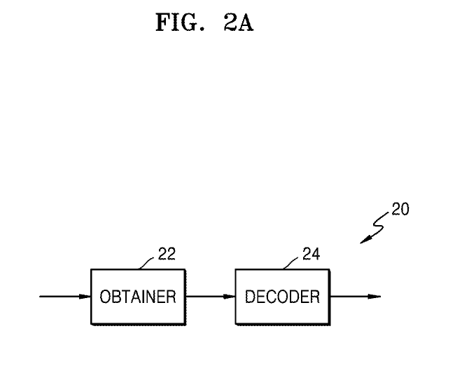

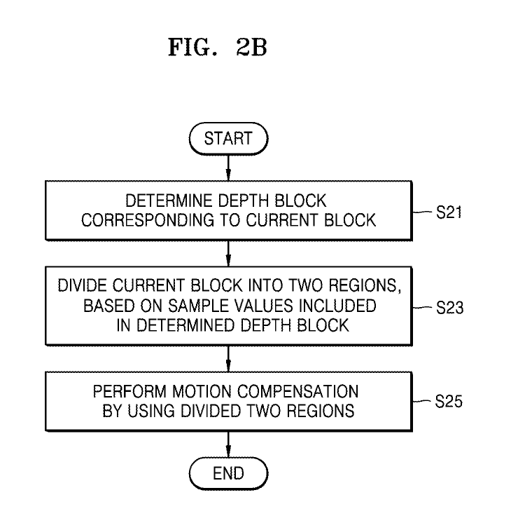

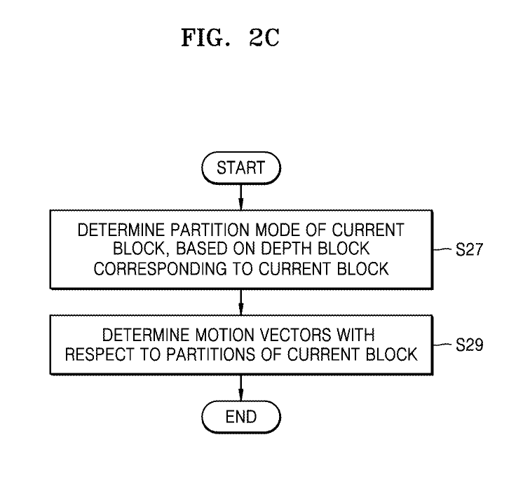

FIG. 2A is a block diagram of a multi-layer video decoding apparatus, according to an embodiment.

Referring to FIG. 2A, a multi-layer video decoding apparatus 20 may include an obtainer 22 and a decoder 24.

The multi-layer video decoding apparatus 20 according to an embodiment may parse, from a bitstream, symbols according to layers.

The multi-layer video decoding apparatus 20 based on spatial scalability may receive a stream in which image sequences having different resolutions are encoded in different layers. A first layer stream may be decoded to reconstruct an image sequence having low resolution and a second layer stream may be decoded to reconstruct an image sequence having high resolution.

As another example, a multiview video may be decoded according to a scalable video coding scheme. When a stereoscopic video stream is decoded to a plurality of layers, a first layer stream may be decoded to reconstruct left-view images. A second layer stream may be further decoded to reconstruct right-view images.

Alternatively, when a multiview video stream is decoded to a plurality of layers, a first layer stream may be decoded to reconstruct central-view images. A second layer stream may be further decoded to reconstruct left-view images. A third layer stream may be further decoded to reconstruct right-view images.

As another example, a scalable video coding method based on temporal scalability may be performed. A first layer stream may be decoded to reconstruct base frame rate images. A second layer stream may be further decoded to reconstruct high frame rate images.

Also, when there are at least three second layers, first layer images may be reconstructed from a first layer stream, and when a second layer stream is further decoded by referring to the reconstructed first layer images, second layer images may be further reconstructed. When K-th layer stream is further decoded by referring to the reconstructed second layer images, K-th layer images may be further reconstructed.

The multi-layer video decoding apparatus 20 may obtain encoded data of first layer images and second layer images from a first layer stream and a second layer stream, and in addition, may further obtain a motion vector generated via inter prediction and prediction information generated via inter-layer prediction.

For example, the multi-layer video decoding apparatus 20 may decode inter-predicted data per layer, and may decode inter-layer predicted data between a plurality of layers. Reconstruction may be performed through motion compensation and inter-layer video decoding based on a coding unit or a prediction unit.

Images may be reconstructed by performing motion compensation for a current image by referring to reconstructed images predicted via inter prediction of a same layer, with respect to each layer stream. Motion compensation is an operation in which a reconstructed image of a current image is reconstructed by synthesizing a reference image determined by using a motion vector of the current image and a residual of the current image.

Also, the multi-layer video decoding apparatus 20 may perform inter-layer video decoding by referring to prediction information of first layer images so as to decode a second layer image predicted via inter-layer prediction. Inter-layer video decoding is an operation in which motion information of a current image is reconstructed by using prediction information of a reference block of a different layer so as to determine the motion information of the current image.

The multi-layer video decoding apparatus 20 according to an embodiment may perform inter-layer video decoding for reconstructing third layer images predicted by using second layer images. An inter-layer prediction structure will be described below with reference to FIG. 3A.

However, the decoder 24 according to an embodiment may decode a second layer stream without referring to a first layer image sequence. Accordingly, it should not be limitedly construed that the decoder 24 performs inter-layer prediction to decode a second layer image sequence.

The multi-layer video decoding apparatus 20 performs decoding according to blocks of each image of a video. A block may be, from among coding units according to a tree structure, a largest coding unit, a coding unit, a prediction unit, or a transformation unit.

The obtainer 22 may receive a bitstream and may obtain information regarding an encoded image from the received bitstream.

The decoder 24 may decode a first layer image by using symbols of a first layer image, the symbols being parsed from the bitstream. When the multi-layer video decoding apparatus 20 receives streams encoded based on coding units of a tree structure, the decoder 24 may perform decoding based on the coding units of the tree structure, according to a largest coding unit of a first layer stream.

The decoder 24 may obtain encoding information and encoded data by performing entropy decoding per largest coding unit. The decoder 24 may reconstruct a residual by performing inverse quantization and inverse transformation on encoded data obtained from a stream. The decoder 24 according to another embodiment may directly receive a bitstream of quantized transformation coefficients. Residual components of images may be reconstructed by performing inverse quantization and inverse transformation on quantized transformation coefficients.

The decoder 24 may determine a prediction image by performing motion compensation between same layer images, and may reconstruct first layer images by combining the prediction image and a residual component.

According to an inter-layer prediction structure, the decoder 24 may generate a second layer prediction image by using samples of a reconstructed first layer image. The decoder 24 may obtain a prediction error according to inter-layer prediction by decoding a second layer stream. The decoder 24 may generate a reconstructed second layer image by combining a second layer prediction image and the prediction error.

The decoder 24 may determine a second layer prediction image by using the reconstructed first layer image decoded by the decoder 24. According to an inter-layer prediction structure, the decoder 24 may determine a block of a first layer image which is to be referred to by a coding unit or a prediction unit of a second layer image. For example, a reconstructed block of the first layer image of which location corresponds to a location of a current block of the second layer image may be determined. The decoder 24 may determine a second layer prediction block by using the reconstructed first layer block corresponding to a second layer block. The decoder 24 may determine the second layer prediction block by using the reconstructed first layer block co-located with the second layer block.

The decoder 24 may use the second layer prediction block determined by using the reconstructed first layer block according to the inter-layer prediction structure, as a reference image for inter-layer prediction of a second layer original block. In this case, the decoder 24 may reconstruct the second layer block by synthesizing a sample value of the second layer prediction block determined by using the reconstructed first layer image and a residual component according to inter-layer prediction.

The multi-layer video decoding apparatus 20 may split a current block into a plurality of regions by using a depth block corresponding to the current block, and may decode the current block, based on the plurality of split regions.

The decoder 24 may determine the depth block corresponding to the current block. For example, the decoder 24 may obtain a disparity vector of the current block from a neighboring block and may determine the depth block corresponding to the current block, based on the obtained disparity vector.

The decoder 24 may split the depth block corresponding to the current block into a plurality of regions, and may split the current block into the plurality of regions, based on the plurality of split regions of the depth block.

The decoder 24 may determine a threshold value so as to split the depth block into the plurality of regions. The threshold value refers to a reference value with respect to the split when the depth block is split into the plurality of regions.

The decoder 24 may determine the threshold value by using sample values of the depth value. For example, the decoder 24 may determine the threshold value by using one or more corner samples included in the depth block. The corner samples may refer to a top-left sample, a bottom-left sample, a top-right sample, and a bottom-right sample in the depth block. The decoder 24 may determine, as the threshold value, an average value of sample values of the top-left sample, the bottom-left sample, the top-right sample, and the bottom-right sample in the depth block.

The decoder 24 may split the depth block into the plurality of regions by using the determined threshold value.

For example, the decoder 24 may split the depth block into a first region and a second region, wherein the first region is a region of samples having sample values greater than the threshold value, and the second region is a region of samples having sample values equal to or less than the threshold value.

The decoder 24 may split the current block into the plurality of regions, based on the plurality of split regions of the depth block corresponding to the current block. For example, when the depth block corresponding to the current block is split into the first region and the second region, the decoder 24 may split the current block into two regions by matching the first region and the second region with the current block.

The decoder 24 may perform motion compensation on the current block by using the plurality of split regions.

For example, the decoder 24 may determine motion vectors respectively for the split two regions of the current block. Then, the decoder 24 may determine respective reference blocks of the respective two regions by using the determined motion vectors, may perform motion compensation on the two regions by using the reference blocks, respectively, and thus may decode the current block.

The decoder 24 may perform inter-layer prediction on the current block by using the plurality of split regions. For example, the decoder 24 may determine disparity vectors respectively for the split two regions of the current block. Then, the decoder 24 may determine respective reference blocks of the respective two regions by using the determined disparity vectors, may perform inter-layer prediction on the two regions by using the reference blocks, respectively, and thus may decode the current block.

The decoder 24 may perform intra prediction on the current block by using the plurality of split regions. For example, the decoder 24 may perform intra prediction on each of the split two regions of the current block.

The decoder 24 may perform a combination of at least two predictions of intra prediction, inter prediction, and inter-layer prediction on the plurality of split regions. For example, the decoder 24 may perform inter prediction on the first region of the split two regions, and may perform inter-layer prediction on the second region. In addition, the decoder 24 may perform inter-layer prediction on the first region of the split two regions, and may perform intra prediction on the second region.

Hereinafter, operations of the multi-layer video decoding apparatus 20 are described in detail with reference to FIGS. 2B and 2C.

FIG. 2B is a flowchart of a multi-layer video decoding method, according to an embodiment.

In operation S21, the multi-layer video decoding apparatus 20 may determine a depth block corresponding to a current block.

According to various embodiments of the present disclosure, the multi-layer video decoding apparatus 20 may obtain a disparity vector of the current block.

The multi-layer video decoding apparatus 20 may obtain the disparity vector of the current block from a neighboring block of the current block.

For example, the multi-layer video decoding apparatus 20 may obtain a disparity vector equal to a disparity vector of the neighboring block of the current block, as the disparity vector of the current block.

In addition, the multi-layer video decoding apparatus 20 may derive the disparity vector of the current block by using the disparity vector of the neighboring block.

For example, the multi-layer video decoding apparatus 20 may derive the disparity vector of the current block by applying a camera parameter to the disparity vector of the neighboring block.

In addition, the multi-layer video decoding apparatus 20 may derive the disparity vector of the current block by applying a camera parameter to predetermined sample values included in a block indicated by the disparity vector of the neighboring block.

The aforementioned method is exemplary, and the multi-layer video decoding apparatus 20 may obtain the disparity vector of the current block by using various methods not limited to the aforementioned method.

The multi-layer video decoding apparatus 20 may determine the depth block corresponding to the current block by using the disparity vector of the current block.

For example, the multi-layer video decoding apparatus 20 may determine, as the depth block corresponding to the current block, a depth block indicated by the disparity vector of the current block at a location of the current block.

The multi multi-layer video decoding apparatus 20 may determine the depth block corresponding to the current block in a depth image corresponding to a view equal to that of the current image. Alternatively, the multi-layer video decoding apparatus 20 may determine the depth block corresponding to the current block in a depth image corresponding to a view different from that of the current image.

For example, when a current image including the current block is a left-view texture image, the multi-layer video decoding apparatus 20 may determine the depth block corresponding to the current block in a left-view depth image.

When the current image including the current block is the left-view texture image, the multi-layer video decoding apparatus 20 may determine the depth block corresponding to the current block in a right-view depth image.

In operation S23, the multi-layer video decoding apparatus 20 may split the current block into two regions, based on sample values included in the determined depth block.

The multi-layer video decoding apparatus 20 may split the depth block corresponding to the current block into a plurality of regions, and may split the current block into a plurality of regions, based on the plurality of split regions of the depth block.

In order to split the current block into the plurality of regions, the multi-layer video decoding apparatus 20 may split the depth block corresponding to the current block into the plurality of regions.

The multi-layer video decoding apparatus 20 may determine a threshold value so as to split the depth block into the plurality of regions. The threshold value refers to a reference value with respect to the split when the depth block is split into the plurality of regions.

The multi multi-layer video decoding apparatus 20 may determine the threshold value by using the sample values of the depth block. For example, the multi-layer video decoding apparatus 20 may determine the threshold value as an average value of the sample values included in the depth block.

The multi-layer video decoding apparatus 20 may determine the threshold value by using one or more corner samples included in the depth block. The corner samples may refer to a top-left sample, a bottom-left sample, a top-right sample, and a bottom-right sample in the depth block.

For example, the multi-layer video decoding apparatus 20 may determine, as the threshold value, an average value of sample values of the top-left sample and the bottom-left sample in the depth block. Alternatively, the multi-layer video decoding apparatus 20 may determine, as the threshold value, an average value of sample values of the top-left sample, the bottom-left sample, the top-right sample, and the bottom-right sample in the depth block.

TH=(a+b+c+d)>>2 (1)

TH=(a+b+c+d+e)>>2 (2)

The multi-layer video decoding apparatus 20 may determine the threshold value by using Equation (1). a refers to a top-left sample value in the depth block, b refers to a top-right sample value in the depth block, c refers to a bottom-left sample value in the depth block, d refers to a bottom-right sample value in the depth block, and TH refers to the threshold value.

The multi-layer video decoding apparatus 20 may obtain the threshold value by rightward shifting a total sum of the top-left sample value, the bottom-left sample value, the top-right sample value, and the bottom-right sample value by 2 bits by using Equation (1).

The multi-layer video decoding apparatus 20 may obtain, as the threshold value, the average value of the sample values of the top-left sample, the bottom-left sample, the top-right sample, and the bottom-right sample in the depth block by using Equation (1).

The multi-layer video decoding apparatus 20 may determine the threshold value by using Equation (2). e refers to a compensation value. The multi-layer video decoding apparatus 20 may obtain the threshold value by rightward shifting a total sum of the top-left sample value, the bottom-left sample value, the top-right sample value, the bottom-right sample value, and the compensation value by 2 bits. e, as the compensation value, may refer to a rounding offset value. The rounding offset value refers to a coefficient capable of determining a rounding degree when the average value of the sample values of the top-left sample, the bottom-left sample, the top-right sample, and the bottom-right sample is calculated.

The multi-layer video decoding apparatus 20 may split the depth block into the plurality of regions by using the determined threshold value.

For example, the multi-layer video decoding apparatus 20 may split the depth block into a first region and a second region, wherein the first region is a region of samples having sample values equal to or greater than the threshold value, and the second region is a region of samples having sample values less than the threshold value. Alternatively, the multi-layer video decoding apparatus 20 may split the depth block into a first region and a second region, wherein the first region is a region of samples having sample values greater than the threshold value, and the second region is a region of samples having sample values equal to or less than the threshold value.

According to various embodiments of the present disclosure, each of the plurality of split regions of the depth block may have a random shape. For example, when the sample values in the depth block are asymmetrically distributed in the depth block, each of the split regions of the depth block may have the random shape.

The multi-layer video decoding apparatus 20 may split the current block into a plurality of regions, based on a division shape of the depth block corresponding to the current block. For example, when the depth block corresponding to the current block is split into a first region and a second region, the multi-layer video decoding apparatus 20 may split the current block into two regions by matching the first region and the second region with the current block.

For example, the multi-layer video decoding apparatus 20 may split the current block into a region of samples of the current block, the samples corresponding to locations of samples included in the first region of the depth block, and a region of samples of the current block, the samples corresponding to locations of samples included in the second region of the depth block.

Also, the multi-layer video decoding apparatus 20 may split the current block into two regions by matching boundaries of the first and second regions of the depth block with the current block.

Also, the multi-layer video decoding apparatus 20 may generate a division map by using the first and second regions of the depth block, and may split the current block into two regions by matching the generated division map with the current block.

According to various embodiments of the present disclosure, each of the plurality of split regions of the current block may have a random shape. For example, when the sample values in the depth block are asymmetrically distributed in the depth block, each of the split regions of the depth block may have the random shape, and the multi-layer video decoding apparatus 20 may split the current block into a plurality of regions that each have a random shape by matching the plurality of split regions of the depth block with the current block.

In operation S25, the multi-layer video decoding apparatus 20 may perform motion compensation by using the split two regions.

The multi-layer video decoding apparatus 20 may perform motion compensation on the current block by using the plurality of split regions.

For example, the multi-layer video decoding apparatus 20 may determine motion vectors respectively for the split two regions of the current block. Then, the multi-layer video decoding apparatus 20 may determine respective reference blocks of the respective two regions by using the determined motion vectors, may perform motion compensation on the two regions by using the reference blocks, respectively, and thus may decode the current block.

The multi-layer video decoding apparatus 20 may perform inter-layer prediction on the current block by using the plurality of split regions.

For example, the multi-layer video decoding apparatus 20 may determine disparity vectors respectively for the split two regions of the current block. Then, the multi-layer video decoding apparatus 20 may determine respective reference blocks of the respective two regions by using the determined disparity vectors, may perform inter-layer prediction on the two regions by using the reference blocks, respectively, and thus may decode the current block.

The multi-layer video decoding apparatus 20 may perform intra prediction on the current block by using the plurality of split regions. For example, the multi-layer video decoding apparatus 20 may perform intra prediction on each of the split two regions of the current block.

The multi-layer video decoding apparatus 20 may perform a combination of at least two predictions of intra prediction, inter prediction, and inter-layer prediction on the plurality of split regions. For example, the multi-layer video decoding apparatus 20 may perform inter prediction on the first region of the split two regions, and may perform inter-layer prediction on the second region. In addition, the multi-layer video decoding apparatus 20 may perform inter-layer prediction on the first region of the split two regions, and may perform intra prediction on the second region.

FIG. 2C is a flowchart of a method of determining a partition mode of a current block and determining motion vectors based on the determined partition mode, the method being performed by the multi-layer video decoding apparatus 20, according to an embodiment.

In operation S27, the multi-layer video decoding apparatus 20 may determine the partition mode of the current block, based on a depth block corresponding to the current block.

The multi-layer video decoding apparatus 20 may determine the partition mode of the current block, based on the depth block corresponding to the current block. For example, the multi-layer video decoding apparatus 20 may determine the partition mode of the current block, based on sample values in the depth block corresponding to the current block.

When the multi-layer video decoding apparatus 20 determines the partition mode of the current block, the multi-layer video decoding apparatus 20 may determine the partition mode as one of limited partition modes. For example, the multi-layer video decoding apparatus 20 may determine the partition mode of the current block as one of PART_2N×N and PART_N×2N.

The multi-layer video decoding apparatus 20 may determine the partition mode as one of the limited partition modes by using the sample values of the depth block corresponding to the current block. For example, the multi-layer video decoding apparatus 20 may determine the partition mode of the current block as one of PART_2N×N and PART_N×2N by using at least one sample of corner samples of the depth block corresponding to the current block.

For example, when an absolute value of (a top-left sample value—a top-right sample value) in the depth block corresponding to the current block exceeds an absolute value of (the top-left sample value—a bottom-left sample value), the multi-layer video decoding apparatus 20 may determine the partition mode of the current block as PART_N×2N. When the absolute value of (the top-left sample value—the top-right sample value) in the depth block corresponding to the current block is equal to or less than the absolute value of (the top-left sample value—the bottom-left sample value), the multi-layer video decoding apparatus 20 may determine the partition mode of the current block as PART_2N×N.

As another example, when the top-left sample value of the depth block corresponding to the current block is less than a bottom-right sample value and a top-right sample value is less than the bottom-left sample value, and when the top-left sample value is equal to or greater than the bottom-right sample value and the top-right sample value is equal to or greater than the bottom-left sample value, the multi-layer video decoding apparatus 20 may determine the partition mode of the current block as PART_2N×N, otherwise, the multi-layer video decoding apparatus 20 may determine the partition mode of the current block as PART_N×2N.

According to another embodiment, the multi-layer video decoding apparatus 20 may obtain, from a bitstream, partition information indicating the partition mode of the current block. Then, the multi-layer video decoding apparatus 20 may determine the partition mode of the current block, based on the obtained partition information.

For example, when the multi-layer video decoding apparatus 20 obtains the partition information regarding the current block from the bitstream, and the obtained partition information indicates PART_2N×N, the multi-layer video decoding apparatus 20 may determine the partition mode of the current block as PART_2N×N.

In operation S29, the multi-layer video decoding apparatus 20 may determine motion vectors with respect to partitions of the current block.

The multi-layer video decoding apparatus 20 may obtain the motion vector and/or the disparity vector which is used in decoding and is with respect to each of the plurality of regions of the current block split in operation S23.

The multi-layer video decoding apparatus 20 may determine a motion vector and/or a disparity vector of each of the partitions of the determined partition mode, by using the obtained motion vector and/or the obtained disparity vector.

For example, when the multi-layer video decoding apparatus 20 determines the partition mode of the current block as PART_2N×N, the multi-layer video decoding apparatus 20 may determine, as a motion vector of a top partition of the current block, a motion vector of a first region from among the plurality of split regions of the current block, the first region including the top-left sample, and may determine a motion vector of a second region of the current block as a motion vector of a bottom partition of the current block.

As another example, when the multi-layer video decoding apparatus 20 determines the partition mode of the current block as PART_2N×N, the multi-layer video decoding apparatus 20 may determine, as the motion vector of the bottom partition of the current block, the motion vector of the first region from among the plurality of split regions of the current block, the first region including the top-left sample, and may determine the motion vector of the second region of the current block as the motion vector of the top partition.

As another example, when the multi-layer video decoding apparatus 20 determines the partition mode of the current block as PART_N×2N, the multi-layer video decoding apparatus 20 may determine, as a motion vector of a left partition of the current block, the motion vector of the first region of the current block, the first region including the top-left sample, and may determine the motion vector of the second region of the current block as a motion vector of a right partition of the current block.

As another example, when the multi-layer video decoding apparatus 20 determines the partition mode of the current block as PART_N×2N, the multi-layer video decoding apparatus 20 may determine, as the motion vector of the right partition of the current block, the motion vector of the first region of the current block, the first region including the top-left sample, and may determine the motion vector of the second region of the current block as a motion vector of a left partition of the current block.

The aforementioned descriptions are exemplary, and the multi-layer video decoding apparatus 20 may determine the motion vector and/or the disparity vector of each of the partitions of the determined partition mode by using a motion vector and/or a disparity vector of each of the plurality of split regions of the current block, according to various methods.

The multi-layer video decoding apparatus 20 may store the determined motion vectors based on the partition mode of the current block. For example, when the partition mode of the current block corresponds to PART_N×2N, the multi-layer video decoding apparatus 20 may store the motion vector of the left partition and the motion vector of the right partition of the current block. The multi-layer video decoding apparatus 20 may decode, by using the stored motion vectors, blocks that are to be decoded after the current block in decoding order.

FIG. 3A illustrates an inter-layer prediction structure, according to an embodiment.

The multi-layer video encoding apparatus 10 according to an embodiment may prediction-encode base view images, left-view images, and right-view images according to a reproduction order 50 of a multiview video prediction structure of FIG. 3A.

According to an embodiment, the base view image, the left-view image, and the right-view image may correspond to images of different layers, respectively. For example, a base view may correspond to a first layer, a left view may correspond to a second layer, and a right view may correspond to a third layer.

According to the reproduction order 50 of the multiview video prediction structure according to a related technology, images of the same view are arranged in a horizontal direction. Accordingly, the left-view images indicated by ‘Left’ are arranged in the horizontal direction in a row, the base view images indicated by ‘Center’ are arranged in the horizontal direction in a row, and the right-view images indicated by ‘Right’ are arranged in the horizontal direction in a row. Compared to the left/right-view images, the base view images may be central-view images.

Also, images having a same picture order count (POC) order are arranged in a vertical direction. A POC order of images indicates a reproduction order of images forming a video. ‘POC X’ indicated in the reproduction order 50 of the multiview video prediction structure indicates a relative reproduction order of images in a corresponding column, wherein a reproduction order is in front when a value of X is low, and is behind when the value of X is high.

Thus, according to the reproduction order 50 of the multiview video prediction structure according to the related technology, the left-view images indicated by ‘Left’ are arranged in the horizontal direction according to the POC order (reproduction order), the base view images indicated by ‘Center’ are arranged in the horizontal direction according to the POC order (reproduction order), and the right-view images indicated by ‘Right’ are arranged in the horizontal direction according to the POC order (reproduction order). Also, the left-view image and the right-view image located on the same column as the base view image have different views but the same POC order (reproduction order).

Four consecutive images form one group of pictures (GOP) according to views. Each GOP includes images between consecutive anchor pictures, and one anchor picture (key picture).

An anchor picture is a random access point, and when a reproduction location is arbitrarily selected from images arranged according to a reproduction order, i.e., a POC order, while reproducing a video, an anchor picture closest to the reproduction location according to the POC order is reproduced. The base layer images include base layer anchor pictures 51, 52, 53, 54, and 55, the left-view images include left view anchor pictures 131, 132, 133, 134, and 135, and the right-view images include right view anchor pictures 231, 232, 233, 234, and 235.

Multiview images may be reproduced and predicted (reconstructed) according to a GOP order. First, according to the reproduction order 50 of the multiview video prediction structure, images included in GOP 0 may be reproduced, and then images included in GOP 1 may be reproduced, according to views. In other words, images included in each GOP may be reproduced in an order of GOP 0, GOP 1, GOP 2, and GOP 3. Also, according to a coding order of the multiview video prediction structure, the images included in GOP 1 may be predicted (reconstructed), and then the images included in GOP 1 may be predicted (reconstructed), according to views. In other words, the images included in each GOP may be predicted (reconstructed) in an order of GOP 0, GOP 1, GOP 2, and GOP 3.

According to the reproduction order 50 of the multiview video prediction structure, inter-view prediction (inter-layer prediction) and inter prediction are performed on images. In the multiview video prediction structure, an image where an arrow starts is a reference image, and an image where an arrow ends is an image predicted by using a reference image.

A prediction result of base view images may be encoded and then output in a form of a base view image stream, and a prediction result of additional view images may be encoded and then output in a form of a layer bitstream. Also, a prediction encoding result of left-view images may be output as a first layer bitstream, and a prediction encoding result of right-view images may be output as a second layer bitstream.

Only inter-prediction is performed on base view images. In other words, the base layer anchor pictures 51, 52, 53, 54, and 55 of an I-picture type do not refer to other images, but remaining images of B- and b-picture types are predicted by referring to other base view images. Images of a B-picture type are predicted by referring to an anchor picture of an I-picture type, which precedes the images of a B-picture type according to a POC order, and a following anchor picture of an I-picture type. Images of a b-picture type are predicted by referring to an anchor picture of an I-type, which precedes the image of a b-picture type according a POC order, and a following image of a B-picture type, or by referring to an image of a B-picture type, which precedes the images of a b-picture type according to a POC order, and a following anchor picture of an I-picture type.

Inter-view prediction (inter-layer prediction) that references different view images, and inter prediction that references same view images are performed on each of left-view images and right-view images.

Inter-view prediction (inter-layer prediction) may be performed on the left view anchor pictures 131, 132, 133, 134, and 135 by respectively referring to the base view anchor pictures 51, 52, 53, 54, and 55 having the same POC order. Inter-view prediction may be performed on the right view anchor pictures 231, 232, 233, 234, and 235 by respectively referring to the base view anchor pictures 51, 52, 53, 54, and 55 or the left view anchor pictures 131, 132, 133, 134, and 135 having the same POC order. Also, inter-view prediction (inter-layer prediction) may be performed on remaining images other than the left-view images 131, 132, 133, 134, and 135 and the right-view images 231, 232, 233, 234, and 235 by referring to other view images having the same POC.

Remaining images other than the anchor pictures 131, 132, 133, 134, and 135 and 231, 232, 233, 234, and 235 from among left-view images and right-view images are predicted by referring to the same view images.

However, each of the left-view images and the right-view images may not be predicted by referring to an anchor picture that has a preceding reproduction order from among additional view images of the same view. In other words, in order to perform inter prediction on a current left-view image, left-view images excluding a left view anchor picture that precedes the current left-view image in a reproduction order may be referenced. Equally, in order to perform inter prediction on a current right-view image, right-view images excluding a right view anchor picture that precedes the current right-view image in a reproduction order may be referenced.

Also, in order to perform inter prediction on a current left-view image, prediction may be performed by referring to a left-view image that belongs to a current GOP but is to be reconstructed before the current left-view image, instead of referring to a left-view image that belongs to a GOP before the current GOP of the current left-view image. The same is applied to a right-view image.

The multi-layer video decoding apparatus 20 according to an embodiment may reconstruct base view images, left-view images, and right-view images according to the reproduction order 50 of the multiview video prediction structure of FIG. 3A.

Left-view images may be reconstructed via inter-view disparity compensation that references base view images and inter motion compensation that references left-view images. Right-view images may be reconstructed via inter-view disparity compensation that references base view images and left-view images, and inter motion compensation that references right-view images. Reference images have to be reconstructed first for disparity compensation and motion compensation with respect to left-view images and right-view images.

For inter motion compensation of a left-view image, left-view images may be reconstructed via inter motion compensation that references a reconstructed left view reference image. For inter motion compensation of a right-view image, right-view images may be reconstructed via inter motion compensation that references a reconstructed right view reference image.

Also, for inter motion compensation of a current left-view image, only a left-view image that belongs to a current GOP of the current left-view image but is to be reconstructed before the current left-view image may be referenced, and a left-view image that belongs to a GOP before the current GOP is not referenced. The same is applied to a right-view image.

Also, the multi-layer video decoding apparatus 20 according to an embodiment may not only perform disparity compensation (or inter-layer prediction compensation) so as to encode or decode a multiview image, but may also perform motion compensation between images (or inter-layer motion prediction and compensation) via inter-view motion vector prediction.

FIG. 3B illustrates a multi-layer video, according to an embodiment.

In order to provide an optimal service through various network environments and various terminals, the multi-layer video encoding apparatus 10 may output a scalable bitstream by encoding multi-layer image sequences having various spatial resolutions, various qualities, various frame-rates, and different views. That is, the multi-layer video encoding apparatus 10 may generate a video bitstream by encoding an input image according to various scalability types and may output the video bitstream. Scalability includes temporal scalability, spatial scalability, quality scalability, multi-view scalability, and combinations thereof. The scalabilities may be classified according to types. Also, the scalabilities may be identified as dimension identifiers in the types.

For example, scalability has scalability types including temporal scalability, spatial scalability, quality scalability, multi-view scalability, or the like. According to the types, the scalabilities may be identified as dimension identifiers. For example, when they have different scalabilities, they may have different dimension identifiers. For example, when a scalability type corresponds to high-dimensional scalability, a higher scalability dimension may be assigned thereto.

When a bitstream is dividable into valid substreams, the bitstream is scalable. A spatially scalable bitstream includes substreams having various resolutions. In order to distinguish between different scalabilities in a same scalability type, a scalability dimension is used. The scalability dimension may be referred to as a scalability dimension identifier.

For example, the spatially-scalable bitstream may be divided into substreams having different resolutions such as a quarter video graphics array (QVGA), a video graphics array (VGA), a wide video graphics array (WVGA), or the like. For example, layers respectively having different resolutions may be distinguished therebetween by using dimension identifiers. For example, a QVGA substream may have 0 as a value of a spatial scalability dimension identifier, a VGA substream may have 1 as a value of the spatial scalability dimension identifier, and a WVGA substream may have 2 as a value of the spatial scalability dimension identifier.

A temporally-scalable bitstream includes substreams having various frame-rates. For example, the temporally-scalable bitstream may be divided into substreams that respectively have a frame-rate of 7.5 Hz, a frame-rate of 15 Hz, a frame-rate of 30 Hz, and a frame-rate of 60 Hz. A quality-scalable bitstream may be divided into substreams having different qualities according to a Coarse-Grained Scalability (CGS) scheme, a Medium-Grained Scalability (MGS) scheme, and a Fine-Grained Scalability (FGS) scheme. The temporally-scalable bitstream may also be divided into different dimensions according to different frame-rates, and the quality-scalable bitstream may also be divided into different dimensions according to the different schemes.

A multi-view scalable bitstream includes substreams having different views in one bitstream. For example, a bitstream of a stereoscopic video includes a left-view image and a right-view image. Also, a scalable bitstream may include substreams with respect to encoded data of a multi-view image and a depth map. View-scalability may be divided into different dimensions according to views.

Different scalable extension types may be combined with each other. That is, a scalable video bitstream may include substreams obtained by encoding image sequences of multiple layers including images where one or more of temporal, spatial, quality, and multi-view scalabilities are different therebetween.

FIG. 3B illustrates image sequences 3010, 3020, and 3030 having different scalability extension types. The image sequence 3010 corresponds to a first layer, the image sequence 3020 corresponds to a second layer, and the image sequence 3030 corresponds to an n-th layer (where n denotes an integer). The image sequences 3010, 3020, and 3030 may be different from each other in at least one of a resolution, a quality, and a view. Also, an image sequence of one layer among the image sequence 3010 of the first layer, the image sequence 3020 of the second layer, and the image sequence 3030 of the n-th layer may be an image sequence of a base layer, and image sequences of the other layers may be image sequences of enhancement layers.

For example, the image sequence 3010 of the first layer may be images corresponding to a first view, the image sequence 3020 of the second layer may be images corresponding to a second view, and the image sequence 3030 of the n-th layer may be images corresponding to an n-th view. As another example, the image sequence 3010 of the first layer may be left-view images of a base layer, the image sequence 3020 of the second layer may be right-view images of the base layer, and the image sequence 3030 of the n-th layer may be right-view images of an enhancement layer. The image sequences 3010, 3020, and 3030 having different scalability extension types are not limited thereto and may be image sequences having image attributes that are different from each other.

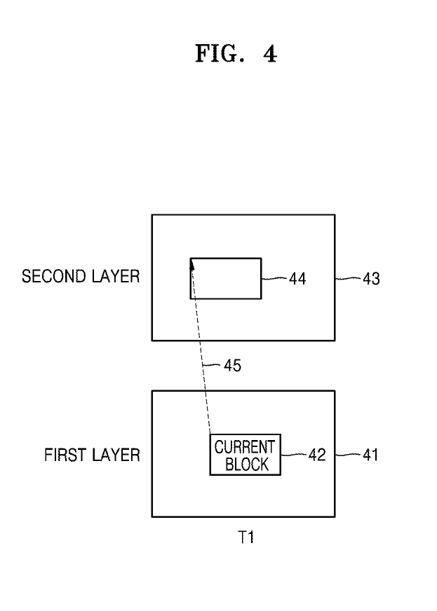

FIG. 4 is a diagram for describing a method of determining a depth block corresponding to a current block, the method being performed by the multi-layer video decoding apparatus 20, according to an embodiment.

The multi-layer video decoding apparatus 20 may obtain a disparity vector 45 of a current block 42.

For example, the multi-layer video decoding apparatus 20 may obtain a disparity vector equal to a disparity vector of a neighboring block of the current block 42, as the disparity vector 45 of the current block 42.

In addition, the multi-layer video decoding apparatus 20 may derive the disparity vector 45 of the current block 42 by using the disparity vector of the neighboring block.

For example, the multi-layer video decoding apparatus 20 may derive the disparity vector 45 of the current block 42 by applying a camera parameter to the disparity vector of the neighboring block.

In addition, the multi-layer video decoding apparatus 20 may derive the disparity vector 45 of the current block 42 by applying a camera parameter to predetermined sample values included in a block indicated by the disparity vector of the neighboring block.

The aforementioned method is exemplary, and the multi-layer video decoding apparatus 20 may obtain the disparity vector 45 of the current block 42 by using various methods not limited to the aforementioned method.

The multi-layer video decoding apparatus 20 may search for a second layer block 44 corresponding to the current block 42 of a first layer by using the disparity vector 45.

For example, the multi-layer video decoding apparatus 20 may detect, by using a location of the current block 42 and the disparity vector 45, the second layer block 44 that is in a second layer picture 43 corresponding to a current picture 41 and corresponds to the current block 42.

The second layer picture 43 may be a depth image having a same view as a first layer. For example, when the current picture 41 that is a first layer picture is a left-view texture picture, the second layer picture 43 may be a left-view depth picture.

Alternatively, the second layer picture 43 may be a depth image having a different view from the first layer. For example, when the first layer picture 41 is a left-view texture picture, the second layer picture 43 may be a right-view depth picture.

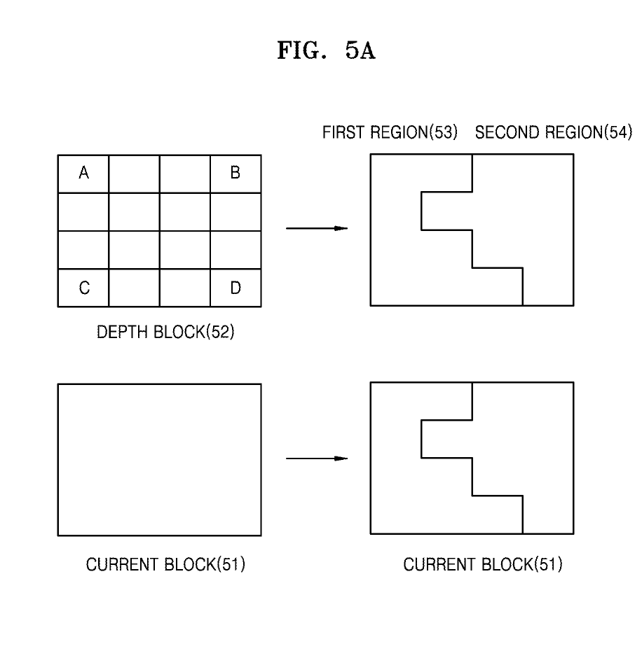

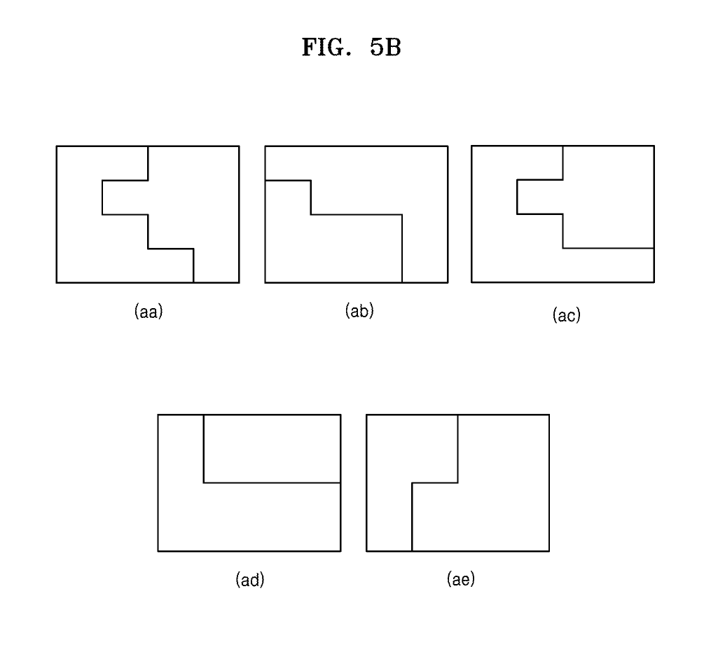

FIG. 5A is a diagram for describing a method of splitting a current block into two regions, the method being performed by the multi-layer video decoding apparatus 20, according to an embodiment.

The multi-layer video decoding apparatus 20 may split a depth block 52 corresponding to a current block 51 into a plurality of regions, and may split the current block 51 into a plurality of regions, based on the plurality of split regions of the depth block 52.

In order to split the current block 51 into the plurality of regions, the multi-layer video decoding apparatus 20 may split the depth block 52 corresponding to the current block 51 into the plurality of regions.

The multi-layer video decoding apparatus 20 may determine a threshold value so as to split the depth block 52 into the plurality of regions. The threshold value refers to a reference value with respect to the split when the depth block 52 is split into the plurality of regions.

The multi multi-layer video decoding apparatus 20 may determine the threshold value by using sample values of the depth block 52. For example, the multi-layer video decoding apparatus 20 may determine the threshold value as an average value of the sample values included in the depth block 52.

The multi-layer video decoding apparatus 20 may determine the threshold value by using one or more corner samples included in the depth block 52. The corner samples may refer to a top-left sample A, a bottom-left sample B, a top-right sample C, and a bottom-right sample D in the depth block 52. For example, the multi-layer video decoding apparatus 20 may determine, as the threshold value, an average value of sample values of the top-left sample A, the bottom-left sample C, the top-right sample B, and the bottom-right sample D in the depth block 52.

TH=(a+b+c+d)>>2 (1)

TH=(a+b+c+d+e)>>2 (2)

In addition, the multi-layer video decoding apparatus 20 may determine the threshold value by using Equation (1). a refers to a top-left sample value in the depth block 52, b refers to a top-right sample value in the depth block 52, c refers to a bottom-left sample value in the depth block 52, d refers to a bottom-right sample value in the depth block 52, and TH refers to the threshold value.

The multi-layer video decoding apparatus 20 may obtain the threshold value by rightward shifting a total sum of the top-left sample value, the bottom-left sample value, the top-right sample value, and the bottom-right sample value by 2 bits by using Equation (1).

The multi-layer video decoding apparatus 20 may obtain, as the threshold value, the average value of the sample values of the top-left sample, the bottom-left sample, the top-right sample, and the bottom-right sample by using Equation (1).

The multi-layer video decoding apparatus 20 may determine the threshold value by using Equation (2). e refers to a compensation value. The multi-layer video decoding apparatus 20 may obtain the threshold value by rightward shifting a total sum of the top-left sample value, the bottom-left sample value, the top-right sample value, the bottom-right sample value, and the compensation value by 2 bits. e, as the compensation value, may refer to a rounding offset value. The rounding offset value refers to a coefficient capable of determining a rounding degree when the average value of the sample values of the top-left sample, the bottom-left sample, the top-right sample, and the bottom-right sample is calculated.

Referring to FIG. 5A, the multi-layer video decoding apparatus 20 may split the depth block 52 into a first region 53 and a second region 54, wherein the first region 53 is a region of samples having sample values greater than the threshold value, and the second region is a region of samples having sample values equal to or less than the threshold value.

The multi-layer video decoding apparatus 20 may split the current block 51 into the plurality of regions, based on a division shape of the depth block 52 corresponding to the current block 51.

Referring to FIG. 5A, when the depth block 52 corresponding to the current block 51 is split into the first region 53 and the second region 54, the multi-layer video decoding apparatus 20 may split the current block 51 into two regions by matching the first region 53 and the second region 54 with the current block 51.

For example, the multi-layer video decoding apparatus 20 may generate a division map by using the first region 53 and the second region 54 of the depth block 52, and may split the current block 51 into the two regions by matching the generated division map with the current block 51.

FIG. 5B is a diagram illustrating a current block that is split into two regions, according to an embodiment.

According to various embodiments of the present disclosure, each of a plurality of split regions of the current block may have a random shape.

For example, when sample values in a depth block are asymmetrically distributed in the depth block, each of split regions of the depth block may have a random shape, and the multi-layer video decoding apparatus 20 may split the current block into the plurality of regions that each have the random shape by matching the split regions of the depth block with the current block.

Examples aa, ab, ac, ad, and ae of FIG. 5B are obtained in a manner that the multi-layer video decoding apparatus 20 splits the current block into two regions that each have a random shape. However, the split shapes are not limited to the examples, and the multi-layer video decoding apparatus 20 may split the current block into a plurality of regions having various shapes.

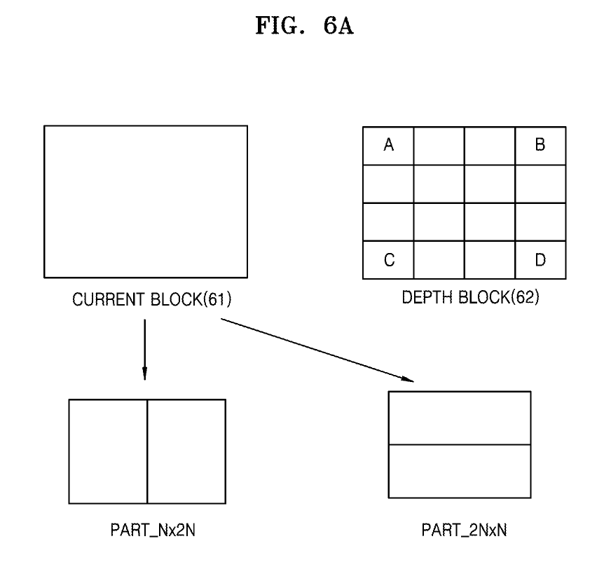

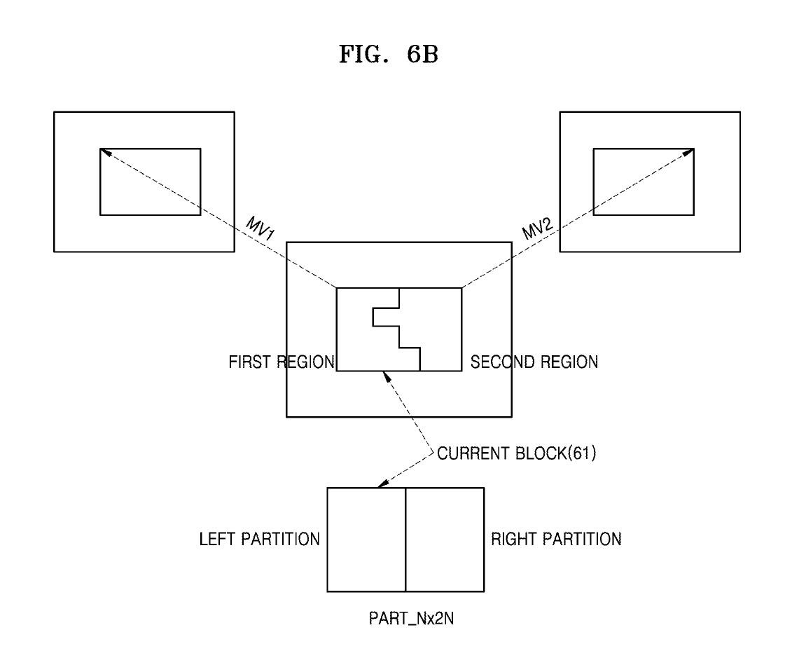

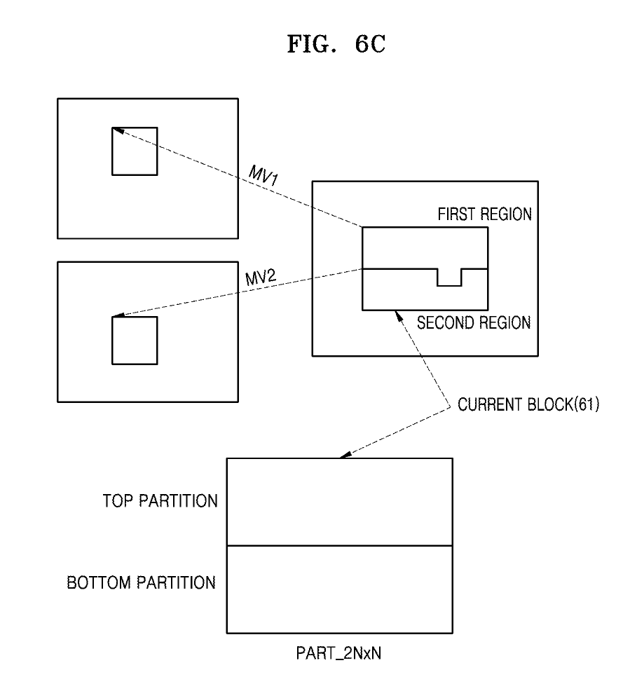

FIG. 6A is a diagram for describing a method of determining a partition mode of a current block, the method being performed by the multi-layer video encoding apparatus 10, according to an embodiment.

The multi-layer video encoding apparatus 10 may determine a partition mode of a current block 61, based on a depth block 62 corresponding to the current block 61. For example, the multi-layer video encoding apparatus 10 may determine the partition mode of the current block 61, based on sample values in the depth block 62 corresponding to the current block 61.

When the multi-layer video encoding apparatus 10 determines the partition mode of the current block 61, the multi-layer video encoding apparatus 10 may determine the partition mode as one of limited partition modes. For example, the multi-layer video encoding apparatus 10 may determine the partition mode of the current block 61 as one of PART_2N×N and PART_N×2N.

The multi-layer video encoding apparatus 10 may determine the partition mode of the current block 61 as one of the limited partition modes by using the sample values of the depth block 62 corresponding to the current block 61.

For example, the multi-layer video encoding apparatus 10 may determine the partition mode of the current block 61 as one of PART_2N×N and PART_N×2N by using at least one sample of corner samples of the depth block 62 corresponding to the current block 61.

if(abs(a−b)>abs(a−c))

{PART_N×2N}

else

{PART_N×2N} (3)

The multi-layer video encoding apparatus 10 may determine the partition mode of the current block 61 by using Equation (3). a refers to a sample value of a top-left sample A in the depth block 62, b refers to a sample value of a top-right sample B, c refers to a sample value of a bottom-left sample C, and d refers to a sample value of a bottom-right sample D.

For example, when an absolute value of (a top-left sample value—a top-right sample value) in the depth block 62 corresponding to the current block 61 exceeds an absolute value of (the top-left sample value—a bottom-left sample value), the multi-layer video encoding apparatus 10 may determine the partition mode of the current block 61 as PART_N×2N. When the absolute value of (the top-left sample value—the top-right sample value) in the depth block 62 corresponding to the current block 61 is equal to or less than the absolute value of (the top-left sample value—the bottom-left sample value), the multi-layer video encoding apparatus 10 may determine the partition mode of the current block 61 as PART_2N×N.

if((a<d)==(b<c))

{PART_N×2N}

else

{PART_N×2N} (4)

As another example, the multi-layer video encoding apparatus 10 may determine the partition mode of the current block 61 by using Equation (4).

For example, when the top-left sample value of the depth block 62 corresponding to the current block 61 is less than a bottom-right sample value and a top-right sample value is less than the bottom-left sample value, and when the top-left sample value is equal to or greater than the bottom-right sample value and the top-right sample value is equal to or greater than the bottom-left sample value, the multi-layer video encoding apparatus 10 may determine the partition mode of the current block 61 as PART_2N×N, otherwise, the multi-layer video encoding apparatus 10 may determine the partition mode of the current block 61 as PART_N×2N.

FIG. 6B is a diagram for describing a method of determining motion vectors with respect to partitions of a current block, according to an embodiment.

The multi-layer video decoding apparatus 20 may split the current block into a plurality of regions, according to the method described with reference to operation S23 of FIG. 2B.

The multi-layer video decoding apparatus 20 may perform motion compensation on the current block by using the plurality of split regions.

For example, the multi-layer video decoding apparatus 20 may determine motion vectors with respect to split two regions of the current block, respectively. A first motion vector MV1 may be determined with respect to a first region of the current block, and a second motion vector MV2 may be determined with respect to a second region.

The multi-layer video decoding apparatus 20 may determine reference blocks of the two regions, respectively, by using the determined motion vectors, may perform motion compensation on each of the two regions by using the reference blocks, and thus may decode the current block.

The multi-layer video decoding apparatus 20 may determine a partition mode of the current block. For example, the multi-layer video decoding apparatus 20 may determine the partition mode of the current block, based on information obtained from a bitstream. Alternatively, the multi-layer video decoding apparatus 20 may determine the partition mode of the current block, based on sample values of a depth block corresponding to the current block.

The multi-layer video decoding apparatus 20 may determine a motion vector of each of the partitions of the determined partition mode by using the motion vectors MV1 and MV2 used in decoding.

For example, when the multi-layer video decoding apparatus 20 determines the partition mode of the current block as PART_N×2N, the multi-layer video decoding apparatus 20 may determine the motion vector MV1 of the first region including a top-left sample as a motion vector of a left partition of the current block, and may determine the motion vector MV2 of the current block as a motion vector of a right partition of the current block.

The aforementioned descriptions are exemplary, and the multi-layer video decoding apparatus 20 may determine the motion vector of each of the partitions of the determined partition mode by using the motion vector of each of the plurality of split regions of the current block, according to various methods.

The multi-layer video decoding apparatus 20 may store the determined motion vectors based on the partition mode of the current block. For example, when the partition mode of the current block corresponds to PART_N×2N, the multi-layer video decoding apparatus 20 may store the motion vector of the left partition and the motion vector of the right partition of the current block. The multi-layer video decoding apparatus 20 may decode, by using the stored motion vectors, blocks that are to be decoded after the current block in decoding order.

When the current block refers to a block of a layer different from a current layer, MV1 and MV2 may indicate disparity vectors. In this case, the multi-layer video decoding apparatus 20 may determine disparity vectors of the left partition and the right partition of the current block, respectively, by using MV1 and MV2.

The aforementioned method is described in terms of the multi-layer video decoding apparatus 20 but may also be applied to the multi-layer video encoding apparatus 10.

FIG. 6C is a diagram for describing a method of determining motion vectors of partitions of a current block when a partition mode of the current block is PART_2N×N, according to an embodiment.

The multi-layer video decoding apparatus 20 may split the current block into a plurality of regions, according to the method described in operation S23 of FIG. 2B.

The multi-layer video decoding apparatus 20 may perform motion compensation on the current block by using the plurality of split regions.

For example, the multi-layer video decoding apparatus 20 may determine motion vectors with respect to two split regions of the current block, respectively. A first motion vector MV1 may be determined with respect to a first region of the current block, and a second motion vector MV2 may be determined with respect to a second region of the current block.

The multi-layer video decoding apparatus 20 may determine reference blocks of the two regions, respectively, by using the determined motion vectors, may perform motion compensation on the two regions by using the reference blocks, respectively, and thus may decode the current block.

The multi-layer video decoding apparatus 20 may determine the partition mode of the current block. For example, the multi-layer video decoding apparatus 20 may determine the partition mode of the current block, based on information obtained from a bitstream.

The multi-layer video decoding apparatus 20 may determine the partition mode of the current block, based on sample values of a depth block corresponding to the current block.

The multi-layer video decoding apparatus 20 may determine respective motion vectors of respective partitions of the determined partition mode by using the motion vectors MV1 and MV2 used in decoding.

For example, when the multi-layer video decoding apparatus 20 determines the partition mode of the current block as PART_2N×N, the multi-layer video decoding apparatus 20 may determine the motion vector of the first region including a top-left sample as a motion vector of a top partition of the current block, and may determine the motion vector of the second region of the current block as a motion vector of a bottom partition of the current block.

The aforementioned descriptions are exemplary, and the multi-layer video decoding apparatus 20 may determine the respective motion vectors of the respective partitions of the determined partition mode by using a motion vector of each of the plurality of split regions of the current block, according to various methods.

The multi-layer video decoding apparatus 20 may store the determined motion vectors based on the partition mode of the current block. For example, when the partition mode of the current block is PART_2N×N, the multi-layer video decoding apparatus 20 may store the motion vector of the top partition and the motion vector of the bottom partition of the current block. The multi-layer video decoding apparatus 20 may decode, by using the stored motion vectors, blocks that are to be decoded after the current block in decoding order.

When the current block refers to a block of a layer different from a current layer, MV1 and MV2 may indicate disparity vectors. In this case, the multi-layer video decoding apparatus 20 may determine disparity vectors of the top partition and the bottom partition of the current block, respectively, by using MV1 and MV2.

The aforementioned method is described in terms of the multi-layer video decoding apparatus 20 but may also be applied to the multi-layer video encoding apparatus 10.

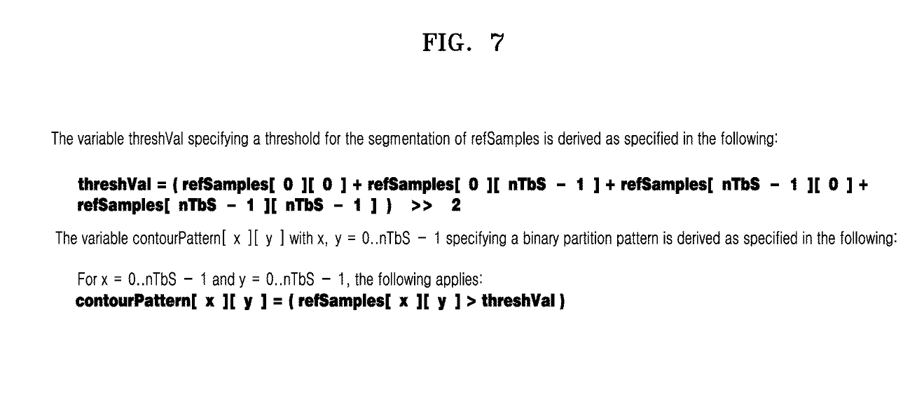

FIG. 7 is a diagram for describing a method of splitting a current block by using a depth block corresponding to the current block, according to an embodiment.

In order to split the current block into a plurality of regions, the multi-layer video decoding apparatus 20 may split the depth block corresponding to the current block into a plurality of regions.

The multi-layer video decoding apparatus 20 may determine a threshold value so as to split the depth block corresponding to the current block into the plurality of regions. The threshold value refers to a reference value with respect to the split when the depth block corresponding to the current block is split into the plurality of regions.

The multi-layer video decoding apparatus 20 may determine the threshold value by using one or more corner samples included in the depth block. The corner samples may refer to a top-left sample, a bottom-left sample, a top-right sample, and a bottom-right sample in the depth block.

For example, the multi-layer video decoding apparatus 20 may determine the threshold value by using a sample value (refSamples[0][0]) of the top-left sample in the depth block, a sample value (refSamples[0][nTbS−1]) of the bottom-left sample in the depth block, a sample value (refSamples[nTbS−1][0]) of the top-right sample in the depth block, and a sample value (refSamples[nTbS−1][nTbS−1]) of the bottom-right sample in the depth block.

The multi-layer video decoding apparatus 20 may determine a threshold value (threshVal) by using an average value of the sample value (refSamples[0][0]) of the top-left sample in the depth block, the sample value (refSamples[0][nTbS−1]) of the bottom-left sample in the depth block, the sample value (refSamples[nTbS−1][0]) of the top-right sample in the depth block, and the sample value (refSamples[nTbS−1][nTbS−1]) of the bottom-right sample in the depth block.

Alternatively, the multi-layer video decoding apparatus 20 may determine the threshold value (threshVal) by performing an add operation on the sample value (refSamples[0][0]) of the top-left sample in the depth block, the sample value (refSamples[0][nTbS−1]) of the bottom-left sample in the depth block, the sample value (refSamples[nTbS−1][0]) of the top-right sample in the depth block, and the sample value (refSamples[nTbS−1][nTbS−1]) of the bottom-right sample in the depth block and then performing rightward shifting on a value of the add operation by 2 bits.

The multi-layer video decoding apparatus 20 may split the depth block into two regions by using the determined threshold value (threshVal).

For example, the multi-layer video decoding apparatus 20 may determine a region as a first region (contourPattern[x][y]), wherein the region indicates a region in the depth block in which samples of which sample values (refSamples[x][y]) are each greater than the threshold value (threshVal).

In addition, the multi-layer video decoding apparatus 20 may determine a region as a second region, wherein the region indicates a region in the depth block in which samples of which sample values (refSamples[x][y]) are each less than or equal to the threshold value (threshVal).

The multi-layer video decoding apparatus 20 may split the current block into the plurality of regions by matching the first region (contourPattern[x][y]) and the second region with the current block.

As described above, the multi-layer video encoding apparatus 10 according to various embodiments and the multi-layer video decoding apparatus 20 according to various embodiments may split blocks of video data into coding units having a tree structure, and coding units, prediction units, and transformation units may be used for inter-layer prediction or inter prediction of coding units. Hereinafter, with reference to FIGS. 8 through 20, a video encoding method, a video encoding apparatus, a video decoding method, and a video decoding apparatus based on coding units having a tree structure and transformation units, according to various embodiments, will be described.

In principle, during encoding and decoding processes for a multi-layer video, encoding and decoding processes for first layer images and encoding and decoding processes for second layer images are separately performed. In other words, when inter-layer prediction is performed on a multi-layer video, encoding and decoding results of single-layer videos may be mutually referred to, but separate encoding and decoding processes are performed according to single-layer videos.

Accordingly, since video encoding and decoding processes based on coding units having a tree structure as described below with reference to FIGS. 8 through 20 for convenience of description are video encoding and decoding processes for processing a single-layer video, only inter prediction and motion compensation are performed. However, as described above with reference to FIGS. 1A through 7, in order to encode and decode a video stream, inter-layer prediction and compensation are performed on base layer images and second layer images.

Accordingly, in order for the encoder 12 of the multi-layer video encoding apparatus 10 according to various embodiments to encode a multi-layer video based on coding units having a tree structure, the multi-layer video encoding apparatus 10 may include as many video encoding apparatuses 100 of FIG. 8 as the number of layers of the multi-layer video so as to perform video encoding according to each single-layer video, thereby controlling each video encoding apparatus 100 to encode an assigned single-layer video. Also, the multi-layer video encoding apparatus 10 may perform inter-view prediction by using encoding results of individual single viewpoints of each video encoding apparatus 100. Accordingly, the encoder 12 of the multi-layer video encoding apparatus 10 may generate a base view video stream and a second layer video stream, which include encoding results according to layers.

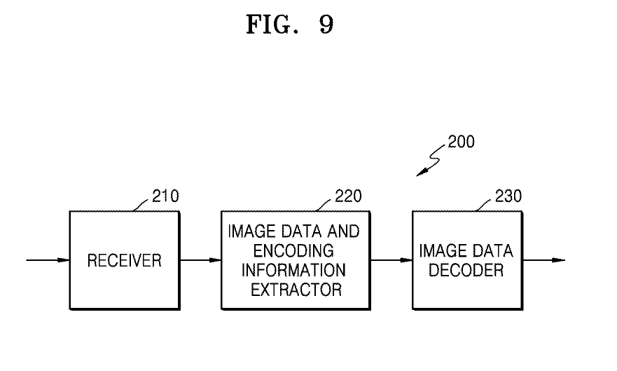

Similarly, in order for the decoder 24 of the multi-layer video decoding apparatus 20 according to various embodiments to decode a multi-layer video based on coding units having a tree structure, the multi-layer video decoding apparatus 20 may include as many video decoding apparatuses 200 of FIG. 9 as the number of layers of the multi-layer video so as to perform video decoding according to layers with respect to a received first layer video stream and a received second layer video stream, thereby controlling each video decoding apparatus 200 to decode an assigned single-layer video. Also, the multi-layer video decoding apparatus 20 may perform inter-layer compensation by using a decoding result of an individual single layer of each video decoding apparatus 200. Accordingly, the decoder 24 of the multi-layer video decoding apparatus 20 may generate first layer images and second layer images which are reconstructed according to layers.

FIG. 8 is a block diagram of a video encoding apparatus based on coding units according to tree structure 100, according to an embodiment.

The video encoding apparatus involving video prediction based on coding units of tree structure 100 according to the embodiment includes a largest coding unit splitter 110, a coding unit determiner 120 and an output unit 130. Hereinafter, for convenience of description, the video encoding apparatus involving video prediction based on coding units of tree structure 100 according to the embodiment will be abbreviated to the ‘video encoding apparatus 100’.

The coding unit determiner 120 may split a current picture based on a largest coding unit that is a coding unit having a maximum size for a current picture of an image. If the current picture is larger than the largest coding unit, image data of the current picture may be split into the at least one largest coding unit. The largest coding unit according to various embodiments may be a data unit having a size of 32×32, 64×64, 128×128, 256×256, etc., wherein a shape of the data unit is a square having a width and length in squares of 2.

A coding unit according to various embodiments may be characterized by a maximum size and a depth. The depth denotes the number of times the coding unit is spatially split from the largest coding unit, and as the depth deepens, deeper coding units according to depths may be split from the largest coding unit to a smallest coding unit. A depth of the largest coding unit is an uppermost depth and a depth of the smallest coding unit is a lowermost depth. Since a size of a coding unit corresponding to each depth decreases as the depth of the largest coding unit deepens, a coding unit corresponding to an upper depth may include a plurality of coding units corresponding to lower depths.

As described above, the image data of the current picture is split into the largest coding units according to a maximum size of the coding unit, and each of the largest coding units may include deeper coding units that are split according to depths. Since the largest coding unit according to various embodiments is split according to depths, the image data of a spatial domain included in the largest coding unit may be hierarchically classified according to depths.

A maximum depth and a maximum size of a coding unit, which limit the total number of times a height and a width of the largest coding unit are hierarchically split, may be previously set.

The coding unit determiner 120 encodes at least one split region obtained by splitting a region of the largest coding unit according to depths, and determines a depth to output a finally encoded image data according to the at least one split region. In other words, the coding unit determiner 120 determines a final depth by encoding the image data in the deeper coding units according to depths, according to the largest coding unit of the current picture, and selecting a depth having the least encoding error. The determined final depth and the encoded image data according to the determined coded depth are output to the output unit 130.

The image data in the largest coding unit is encoded based on the deeper coding units corresponding to at least one depth equal to or below the maximum depth, and results of encoding the image data are compared based on each of the deeper coding units. A depth having the least encoding error may be selected after comparing encoding errors of the deeper coding units. At least one final depth may be selected for each largest coding unit.

The size of the largest coding unit is split as a coding unit is hierarchically split according to depths, and as the number of coding units increases. Also, even if coding units correspond to the same depth in one largest coding unit, it is determined whether to split each of the coding units corresponding to the same depth to a lower depth by measuring an encoding error of the image data of the each coding unit, separately. Accordingly, even when image data is included in one largest coding unit, the encoding errors may differ according to regions in the one largest coding unit, and thus the final depths may differ according to regions in the image data. Thus, one or more final depths may be determined in one largest coding unit, and the image data of the largest coding unit may be divided according to coding units of at least one final depth.

Accordingly, the coding unit determiner 120 according to various embodiments may determine coding units having a tree structure included in the largest coding unit. The ‘coding units having a tree structure’ according to various embodiments include coding units corresponding to a depth determined to be the final depth, from among all deeper coding units included in the largest coding unit. A coding unit of a final depth may be hierarchically determined according to depths in the same region of the largest coding unit, and may be independently determined in different regions. Equally, a final depth in a current region may be independently determined from a final depth in another region.

A maximum depth according to various embodiments is an index related to the number of splitting times from a largest coding unit to a smallest coding unit. A first maximum depth according to various embodiments may denote the total number of splitting times from the largest coding unit to the smallest coding unit. A second maximum depth according to various embodiments may denote the total number of depth levels from the largest coding unit to the smallest coding unit. For example, when a depth of the largest coding unit is 0, a depth of a coding unit, in which the largest coding unit is split once, may be set to 1, and a depth of a coding unit, in which the largest coding unit is split twice, may be set to 2. In this regard, if the smallest coding unit is a coding unit in which the largest coding unit is split four times, depth levels of depths 0, 1, 2, 3, and 4 exist, and thus the first maximum depth may be set to 4, and the second maximum depth may be set to 5.

Prediction encoding and transformation may be performed according to the largest coding unit. The prediction encoding and the transformation are also performed based on the deeper coding units according to a depth equal to or depths less than the maximum depth, according to the largest coding unit.

Since the number of deeper coding units increases whenever the largest coding unit is split according to depths, encoding, including the prediction encoding and the transformation, is performed on all of the deeper coding units generated as the depth deepens. For convenience of description, the prediction encoding and the transformation will now be described based on a coding unit of a current depth, in a largest coding unit.

The video encoding apparatus 100 according to various embodiments may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding in the largest coding unit, the prediction encoding may be performed based on a coding unit corresponding to a final depth according to various embodiments, i.e., based on a coding unit that is no longer split to coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit and a data unit obtained by splitting at least one of a height and a width of the prediction unit. A partition is a data unit where a prediction unit of a coding unit is split, and a prediction unit may be a partition having the same size as a coding unit.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition mode according to various embodiments may selectively include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, or partitions having arbitrary shapes.

A prediction mode of the prediction unit may be at least one of an intra mode, an inter mode, and a skip mode. For example, the intra mode and the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding apparatus 100 according to various embodiments may perform not only the transformation on the image data in a coding unit based not only on the coding unit for encoding the image data, but also may perform the transformation on the image data based on a data unit that is different from the coding unit. In order to perform the transformation in the coding unit, the transformation may be performed based on a transformation unit having a size less than or equal to the coding unit. For example, the transformation unit may include a data unit for an intra mode and a transformation unit for an inter mode.

The transformation unit in the coding unit may be recursively split into smaller sized regions in a manner similar to that in which the coding unit is split according to the tree structure, according to various embodiments. Thus, residual data in the coding unit may be split according to the transformation unit having the tree structure according to transformation depths.

A transformation depth indicating the number of splitting times to reach the transformation unit by splitting the height and width of the coding unit may also be set in the transformation unit according to various embodiments. For example, in a current coding unit of 2N×2N, a transformation depth may be 0 when the size of a transformation unit is 2N×2N, may be 1 when the size of the transformation unit is N×N, and may be 2 when the size of the transformation unit is N/2×N/2. In other words, the transformation unit having the tree structure may be set according to the transformation depths.

Split information according to depths requires not only information about a depth but also requires information related to prediction encoding and transformation. Accordingly, the coding unit determiner 120 not only determines a depth having a least encoding error, but also determines a partition mode of splitting a prediction unit into a partition, a prediction mode according to prediction units, and a size of a transformation unit for transformation.

Coding units according to a tree structure in a largest coding unit and methods of determining a prediction unit/partition, and a transformation unit, according to various embodiments, will be described in detail below with reference to FIGS. 9 through 19.

The coding unit determiner 120 may measure an encoding error of deeper coding units according to depths by using Rate-Distortion Optimization based on Lagrangian multipliers.

The output unit 130 outputs the image data of the largest coding unit, which is encoded based on the at least one depth determined by the coding unit determiner 120, and split information according to the depth, in bitstreams.

The encoded image data may be obtained by encoding residual data of an image.

The split information according to depth may include information about the depth, about the partition mode in the prediction unit, about the prediction mode, and about split of the transformation unit.

The information about the final depth may be defined by using split information according to depths, which indicates whether encoding is performed on coding units of a lower depth instead of a current depth. If the current depth of the current coding unit is a depth, the current coding unit is encoded, and thus the split information may be defined not to split the current coding unit to a lower depth. Alternatively, if the current depth of the current coding unit is not the depth, the encoding is performed on the coding unit of the lower depth, and thus the split information may be defined to split the current coding unit to obtain the coding units of the lower depth.

If the current depth is not the depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one largest coding unit, and split information is determined for a coding unit of a depth, at least one piece of split information may be determined for one largest coding unit. Also, a depth of the image data of the largest coding unit may be different according to locations since the image data is hierarchically split according to depths, and thus a depth and split information may be set for the image data.

Accordingly, the output unit 130 according to various embodiments may assign a corresponding depth and encoding information about an encoding mode to at least one of the coding unit, the prediction unit, and a minimum unit included in the largest coding unit.

The minimum unit according to various embodiments is a square data unit obtained by splitting the smallest coding unit constituting the lowermost depth by 4. Alternatively, the minimum unit according to various embodiments may be a maximum square data unit that may be included in all of the coding units, prediction units, partition units, and transformation units included in the largest coding unit.

For example, the encoding information output by the output unit 130 may be classified into encoding information according to deeper coding units, and encoding information according to prediction units. The encoding information according to the deeper coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Information about a maximum size of the coding unit defined according to pictures, slices, or GOPs, and information about a maximum depth may be inserted into a header of a bitstream, a sequence parameter set, or a picture parameter set.

Information about a maximum size of the transformation unit permitted with respect to a current video, and information about a minimum size of the transformation unit may also be output through a header of a bitstream, a sequence parameter set, or a picture parameter set. The output unit 130 may encode and output reference information related to prediction, motion information, and slice type information.

In the video encoding apparatus 100 according to the simplest embodiment, the deeper coding unit may be a coding unit obtained by dividing a height or width of a coding unit of an upper depth, which is one layer above, by two. That is, when the size of the coding unit of the current depth is 2N×2N, the size of the coding unit of the lower depth is N×N. Also, the coding unit with the current depth having a size of 2N×2N may include a maximum of 4 of the coding units with the lower depth.

Accordingly, the video encoding apparatus 100 may form the coding units having the tree structure by determining coding units having an optimum shape and an optimum size for each largest coding unit, based on the size of the largest coding unit and the maximum depth determined considering characteristics of the current picture. Also, since encoding may be performed on each largest coding unit by using any one of various prediction modes and transformations, an optimum encoding mode may be determined considering characteristics of the coding unit of various image sizes.

Thus, if an image having a high resolution or a large data amount is encoded in a conventional macroblock, the number of macroblocks per picture excessively increases. Accordingly, the number of pieces of compressed information generated for each macroblock increases, and thus it is difficult to transmit the compressed information and data compression efficiency decreases. However, by using the video encoding apparatus 100 according to various embodiments, image compression efficiency may be increased since a coding unit is adjusted while considering characteristics of an image while increasing a maximum size of a coding unit while considering a size of the image.

The multi-layer video encoding apparatus 10 described above with reference to FIG. 1A may include as many video encoding apparatuses 100 as the number of layers, in order to encode single-layer images according to layers of a multi-layer video.

When the video encoding apparatus 100 encodes first layer images, the coding unit determiner 120 may determine, for each largest coding unit, a prediction unit for inter-prediction according to coding units having a tree structure, and may perform inter-prediction according to prediction units.

Even when the video encoding apparatus 100 encodes second layer images, the coding unit determiner 120 may determine, for each largest coding unit, coding units and prediction units having a tree structure, and may perform inter-prediction according to prediction units.

The video encoding apparatus 100 may encode a luminance difference to compensate for a luminance difference between a first layer image and a second layer image. However, whether to perform luminance may be determined according to an encoding mode of a coding unit. For example, luminance compensation may be performed only on a prediction unit having a size of 2N×2N.

FIG. 9 is a block diagram of a video decoding apparatus based on coding units according to tree structure 200, according to various embodiments.

The video decoding apparatus involving video prediction based on coding units according to tree structure 200 according to an embodiment includes a receiver 210, an image data and encoding information extractor 220, and an image data decoder 230. For convenience of description, the video decoding apparatus involving video prediction based on coding units according to tree structure 200 according to an embodiment will be abbreviated to the ‘video decoding apparatus 200’.

Definitions of various terms, such as a coding unit, a depth, a prediction unit, a transformation unit, and various split information, for decoding operations of the video decoding apparatus 200 according to various embodiments are identical to those described with reference to FIG. 8 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each largest coding unit, and outputs the extracted image data to the image data decoder 230. The image data and encoding information extractor 220 may extract information about a maximum size of a coding unit of a current picture, from a header about the current picture, a sequence parameter set, or a picture parameter set.

Also, the image data and encoding information extractor 220 extracts a final depth and split information for the coding units having a tree structure according to each largest coding unit, from the parsed bitstream. The extracted final depth and split information are output to the image data decoder 230. That is, the image data in a bitstream is split into the largest coding unit so that the image data decoder 230 decodes the image data for each largest coding unit.

A depth and split information according to the largest coding unit may be set for at least one piece of depth information, and split information may include information about a partition mode of a corresponding coding unit, about a prediction mode, and about split of a transformation unit. Also, split information according to depths may be extracted as the information about a depth.

The depth and the split information according to each largest coding unit extracted by the image data and encoding information extractor 220 is a depth and split information determined to generate a least encoding error when an encoder, such as the video encoding apparatus 100 according to various embodiments, repeatedly performs encoding for each deeper coding unit according to depths according to each largest coding unit. Accordingly, the video decoding apparatus 200 may reconstruct an image by decoding the image data according to a coded depth and an encoding mode that generates the least encoding error.

Since encoding information according to various embodiments about a depth and an encoding mode may be assigned to a predetermined data unit from among a corresponding coding unit, a prediction unit, and a minimum unit, the image data and encoding information extractor 220 may extract the depth and the split information according to the predetermined data units. If the depth and the split information of a corresponding largest coding unit is recorded according to predetermined data units, the predetermined data units to which the same depth and the same split information is assigned may be inferred to be the data units included in the same largest coding unit.

The image data decoder 230 may reconstruct the current picture by decoding the image data in each largest coding unit based on the depth and the split information according to the largest coding units. That is, the image data decoder 230 may decode the encoded image data based on the extracted information about the partition mode, the prediction mode, and the transformation unit for each coding unit from among the coding units having the tree structure included in each largest coding unit. A decoding process may include a prediction including intra prediction and motion compensation, and an inverse transformation.

The image data decoder 230 may perform intra prediction or motion compensation according to a partition and a prediction mode of each coding unit, based on the information about the partition mode and the prediction mode of the prediction unit of the coding unit according to depths.

In addition, the image data decoder 230 may read information about a transformation unit according to a tree structure for each coding unit so as to perform inverse transformation based on transformation units for each coding unit, for inverse transformation for each largest coding unit. Via the inverse transformation, a pixel value of a spatial region of the coding unit may be reconstructed.

The image data decoder 230 may determine a depth of a current largest coding unit by using split information according to depths. If the split information indicates that image data is no longer split in the current depth, the current depth is a depth. Accordingly, the image data decoder 230 may decode encoded data in the current largest coding unit by using the information about the partition mode of the prediction unit, the prediction mode, and the size of the transformation unit.

That is, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode. As such, the current coding unit may be decoded by obtaining the information about the encoding mode for each coding unit.

The multi-layer video decoding apparatus 20 described above with reference to FIG. 2A may include video decoding apparatuses 200 as much as the number of viewpoints, so as to reconstruct first layer images and second layer images by decoding a received first layer image stream and a received second layer image stream.

When the first layer image stream is received, the image data decoder 230 of the video decoding apparatus 200 may split samples of first layer images extracted from the first layer image stream by the image data and encoding information extractor 220 into coding units having a tree structure. The image data decoder 230 may reconstruct the first layer images by performing motion compensation according to prediction units for inter prediction, on the coding units having the tree structure obtained by splitting the samples of the first layer images.

When the second layer image stream is received, the image data decoder 230 of the video decoding apparatus 200 may split samples of second layer images extracted from the second layer image stream by the image data and encoding information extractor 220 into coding units having a tree structure. The image data decoder 230 may reconstruct the second layer images by performing motion compensation according to prediction units for inter prediction, on the coding units obtained by splitting the samples of the second layer images.

The extractor 220 may obtain information related to a luminance error from a bitstream so as to compensate for a luminance difference between a first layer image and a second layer image. However, whether to perform luminance may be determined according to an encoding mode of a coding unit. For example, luminance compensation may be performed only on a prediction unit having a size of 2N×2N.

Thus, the video decoding apparatus 200 may obtain information about at least one coding unit that generates the least encoding error when encoding is recursively performed for each largest coding unit, and may use the information to decode the current picture. That is, the coding units having the tree structure determined to be the optimum coding units in each largest coding unit may be decoded.

Accordingly, even if an image has high resolution or has an excessively large data amount, the image may be efficiently decoded and reconstructed by using a size of a coding unit and an encoding mode, which are adaptively determined according to characteristics of the image, by using optimum split information received from an encoder.

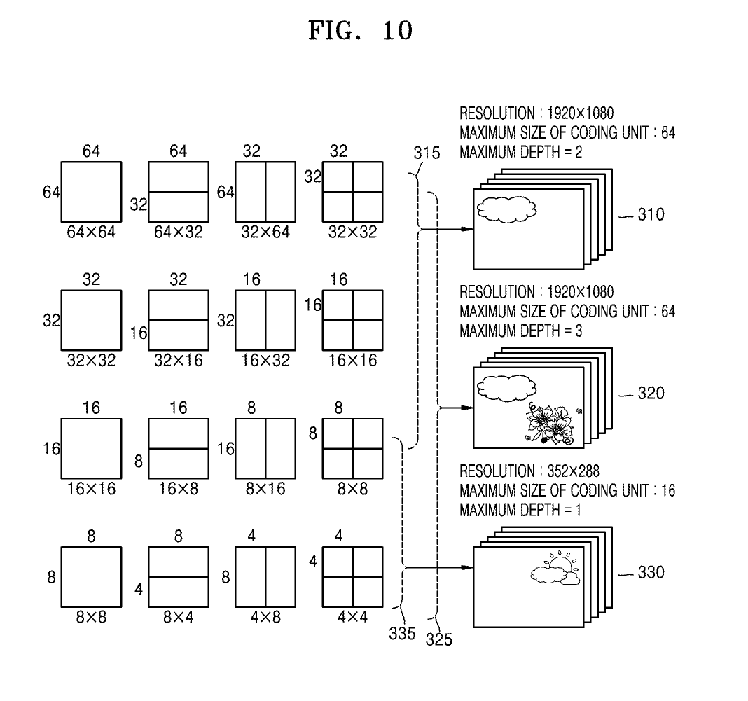

FIG. 10 is a diagram for describing a concept of coding units according to various embodiments.

A size of a coding unit may be expressed by width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 10 denotes a total number of splits from a largest coding unit to a smallest coding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having a higher resolution than the video data 330 may be 64.

Since the maximum depth of the video data 310 is 2, coding units 315 of the vide data 310 may include a largest coding unit having a long axis size of 64, and coding units having long axis sizes of 32 and 16 since depths are deepened to two layers by splitting the largest coding unit twice. Since the maximum depth of the video data 330 is 1, coding units 335 of the video data 330 may include a largest coding unit having a long axis size of 16, and coding units having a long axis size of 8 since depths are deepened to one layer by splitting the largest coding unit once.

Since the maximum depth of the video data 320 is 3, coding units 325 of the video data 320 may include a largest coding unit having a long axis size of 64, and coding units having long axis sizes of 32, 16, and 8 since the depths are deepened to 3 layers by splitting the largest coding unit three times. As a depth deepens, detailed information may be precisely expressed.

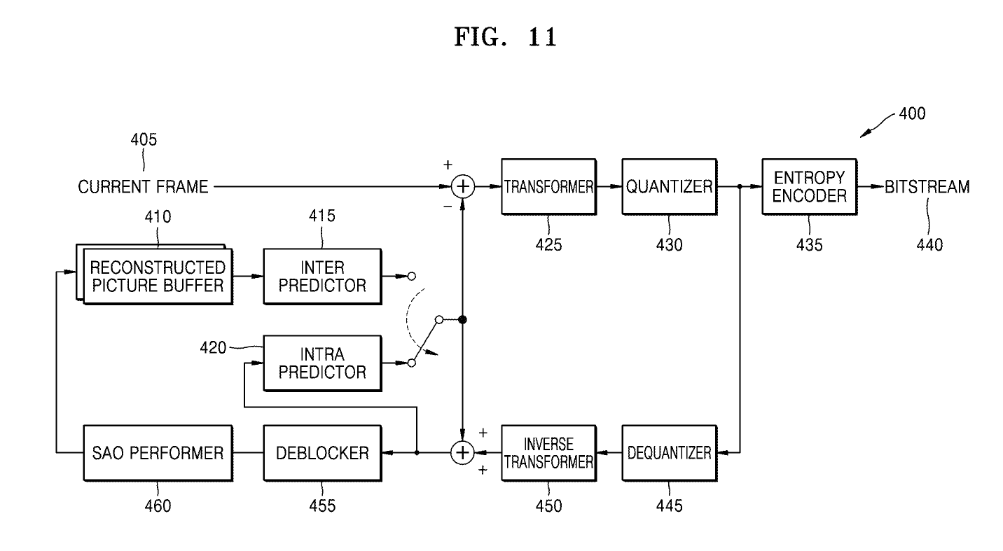

FIG. 11 is a block diagram of an image encoder 400 based on coding units, according to various embodiments.

The image encoder 400 according to various embodiments performs operations of the coding unit determiner 120 of the video encoding apparatus 100 to encode image data. That is, an intra predictor 420 performs intra prediction on coding units in an intra mode, from among a current frame 405, per prediction unit, and an inter predictor 415 performs inter prediction on coding units in an inter mode by using the current image 405 and a reference image obtained by a reconstructed picture buffer 410, per prediction unit. The current picture 405 may be split into largest coding units, and then the largest coding units may be sequentially encoded. Here, the encoding may be performed on coding units split in a tree structure from the largest coding unit.

Residual data is generated by subtracting prediction data of a coding unit of each mode output from the intra predictor 420 or the inter predictor 415 from data of the current image 405 to be encoded, and the residual data is output as a quantized transformation coefficient through a transformer 425 and a quantizer 430 per transformation unit. The quantized transformation coefficient is reconstructed to residual data in a spatial domain through an inverse quantizer 445 and an inverse transformer 450. The residual data in the spatial domain is added to the prediction data of the coding unit of each mode output from the intra predictor 420 or the inter predictor 415 to be reconstructed as data in a spatial domain of the coding unit of the current image 405. The data in the spatial domain passes through a deblocker 455 and a sample adaptive offset (SAO) performer 460 and thus a reconstructed image is generated. The reconstructed image is stored in the reconstructed picture buffer 410. Reconstructed images stored in the reconstructed picture buffer 410 may be used as a reference image for inter prediction of another image. The quantized transformation coefficient obtained through the transformer 425 and the quantizer 430 may be output as a bitstream 440 through an entropy encoder 435.

In order for the image encoder 400 according to various embodiments to be applied in the video encoding apparatus 100, components of the image encoder 400, i.e., the inter predictor 415, the intra predictor 420, the transformer 425, the quantizer 430, the entropy encoder 435, the inverse quantizer 445, the inverse transformer 450, the deblocking unit 455, and the SAO performer 460 perform operations based on each coding unit among coding units having a tree structure per largest coding unit.

In particular, the intra predictor 420 and the inter predictor 415 may determine partitions and a prediction mode of each coding unit from among the coding units having a tree structure while considering the maximum size and the maximum depth of a current largest coding unit, and the transformer 425 may determine whether to split a transformation unit according to a quad-tree in each coding unit from among the coding units having the tree structure.

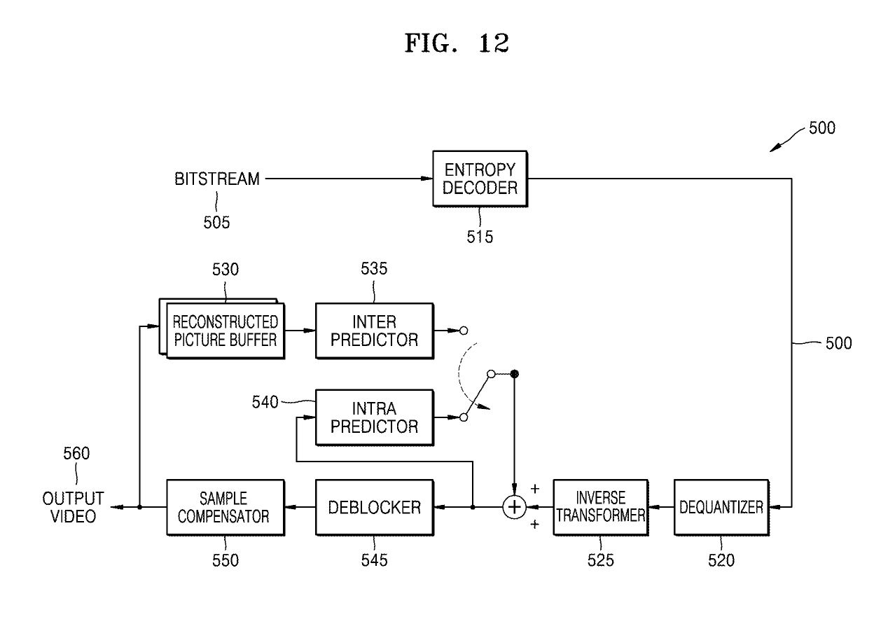

FIG. 12 is a block diagram of an image decoder 500 based on coding units according to various embodiments.

An entropy decoder 515 parses encoded image data that is to be decoded and encoding information required for decoding from a bitstream 505. The encoded image data is a quantized transformation coefficient, and an inverse quantizer 520 and an inverse transformer 525 reconstructs residual data from the quantized transformation coefficient.

An intra predictor 540 performs intra prediction on a coding unit in an intra mode according to prediction units. An inter predictor performs inter prediction on a coding unit in an inter mode from a current image according to prediction units, by using a reference image obtained by a reconstructed picture buffer 530.

Data in a spatial domain of coding units of the current image is reconstructed by adding the residual data and the prediction data of a coding unit of each mode through the intra predictor 540 or the inter predictor 535, and the data in the spatial domain may be output as a reconstructed image through a deblocking unit 545 and an SAO performer 550. Also, reconstructed images that are stored in the reconstructed picture buffer 530 may be output as reference images.

In order to decode the image data in the image data decoder 230 of the video decoding apparatus 200, operations after the entropy decoder 515 of the image decoder 500 according to various embodiments may be performed.

In order for the image decoder 500 to be applied in the video decoding apparatus 200 according to various embodiments, components of the image decoder 500, i.e., the entropy decoder 515, the inverse quantizer 520, the inverse transformer 525, the intra predictor 540, the inter predictor 535, the deblocking unit 545, and the SAO performer 550 may perform operations based on coding units having a tree structure for each largest coding unit.

In particular, the intra prediction 540 and the inter predictor 535 determine a partition mode and a prediction mode according to each of coding units having a tree structure, and the inverse transformer 525 may determine whether to split a transformation unit according to a quad-tree structure per coding unit.

An encoding operation of FIG. 10 and a decoding operation of FIG. 11 are respectively a video stream encoding operation and a video stream decoding operation in a single layer. Accordingly, when the encoder 12 of FIG. 1A encodes a video stream of at least two layers, the video encoding apparatus 10 of FIG. 1A may include as many image encoder 400 as the number of layers. Similarly, when the decoder 24 of FIG. 2A decodes a video stream of at least two layers, the video decoding apparatus 20 of FIG. 2A may include as many image decoders 500 as the number of layers.

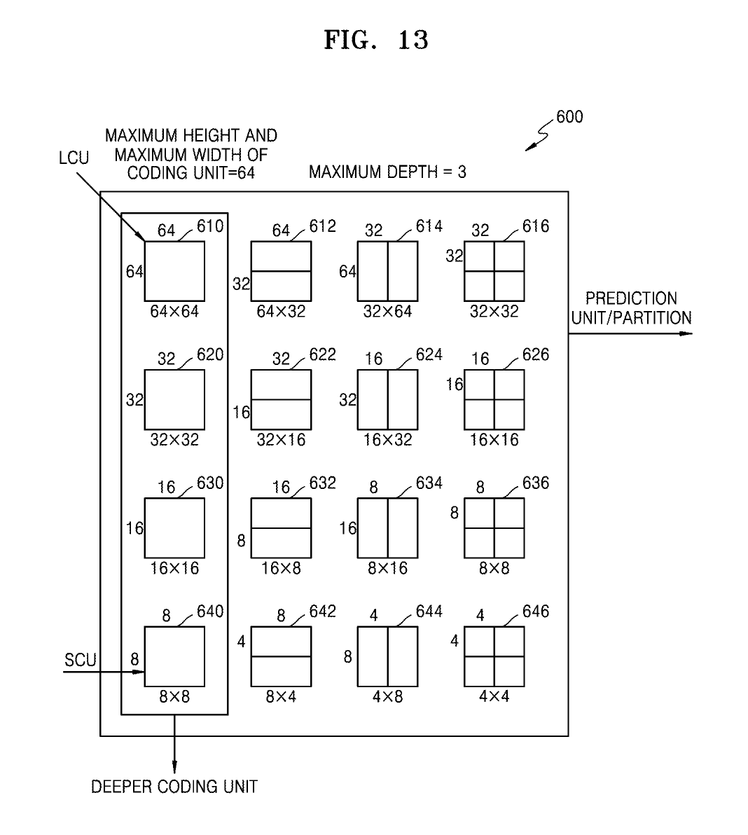

FIG. 13 is a diagram illustrating coding units according to depths and partitions, according to various embodiments.

The video encoding apparatus 100 according to various embodiments and the video decoding apparatus 200 according to various embodiments use hierarchical coding units so as to consider characteristics of an image. A maximum height, a maximum width, and a maximum depth of coding units may be adaptively determined according to the characteristics of the image, or may be variously set according to user requirements. Sizes of deeper coding units according to depths may be determined according to the predetermined maximum size of the coding unit.

In a hierarchical structure 600 of coding units according to various embodiments, the maximum height and the maximum width of the coding units are each 64, and the maximum depth is 3. In this case, the maximum depth refers to a total number of times the coding unit is split from the largest coding unit to the smallest coding unit. Since a depth deepens along a vertical axis of the hierarchical structure 600 of coding units according to various embodiments, a height and a width of the deeper coding unit are each split. Also, a prediction unit and partitions, which are bases for prediction encoding of each deeper coding unit, are shown along a horizontal axis of the hierarchical structure 600.

That is, a coding unit 610 is a largest coding unit in the hierarchical structure 600, wherein a depth is 0 and a size, i.e., a height by width, is 64×64. The depth deepens along the vertical axis, and a coding unit 620 having a size of 32×32 and a depth of 1, a coding unit 630 having a size of 16×16 and a depth of 2, and a coding unit 640 having a size of 8×8 and a depth of 3. The coding unit 640 having a size of 8×8 and a depth of 3 is a smallest coding unit.

The prediction unit and the partitions of a coding unit are arranged along the horizontal axis according to each depth. In other words, if the coding unit 610 having a size of 64×64 and a depth of 0 is a prediction unit, the prediction unit may be split into partitions included in the coding unit 610 having a size of 64×64, i.e. a partition 610 having a size of 64×64, partitions 612 having the size of 64×32, partitions 614 having the size of 32×64, or partitions 616 having the size of 32×32.

Equally, a prediction unit of the coding unit 620 having the size of 32×32 and the depth of 1 may be split into partitions included in the coding unit 620 having a size of 32×32, i.e. a partition 620 having a size of 32×32, partitions 622 having a size of 32×16, partitions 624 having a size of 16×32, and partitions 626 having a size of 16×16.

Equally, a prediction unit of the coding unit 630 having the size of 16×16 and the depth of 2 may be split into partitions included in the coding unit 630 having a size of 16×16, i.e. a partition having a size of 16×16 included in the coding unit 630, partitions 632 having a size of 16×8, partitions 634 having a size of 8×16, and partitions 636 having a size of 8×8.

Equally, a prediction unit of the coding unit 640 having the size of 8×8 and the depth of 3 may be split into partitions included in the coding unit 640 having a size of 8×8, i.e. a partition 640 having a size of 8×8 included in the coding unit 640, partitions 642 having a size of 8×4, partitions 644 having a size of 4×8, and partitions 646 having a size of 4×4.

In order to determine the depth of the largest coding unit 610, the coding unit determiner 120 of the video encoding apparatus 100 according to various embodiments performs encoding for coding units corresponding to each depth included in the maximum coding unit 610.

The number of deeper coding units according to depths including data in the same range and the same size increases as the depth deepens. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the least encoding error may be searched for by comparing the least encoding errors according to depths, by performing encoding for each depth as the depth deepens along the vertical axis of the hierarchical structure 600. A depth and a partition having the least encoding error in the largest coding unit 610 may be selected as the depth and a partition mode of the largest coding unit 610.

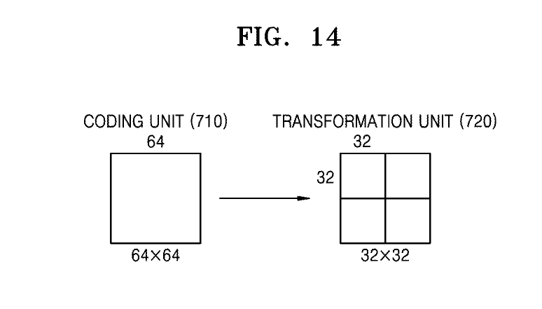

FIG. 14 is a diagram for describing a relationship between a coding unit and transformation units, according to various embodiments.

The video encoding apparatus 100 according to various embodiments or the video decoding apparatus 200 according to various embodiments encodes or decodes an image according to coding units having sizes less than or equal to a largest coding unit for each largest coding unit. Sizes of transformation units for transformation during encoding may be selected based on data units that are not larger than a corresponding coding unit.

For example, in the video encoding apparatus 100 according to various embodiments or the video decoding apparatus 200 according to various embodiments, if a size of a coding unit 710 is 64×64, transformation may be performed by using a transformation unit 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error may be selected.

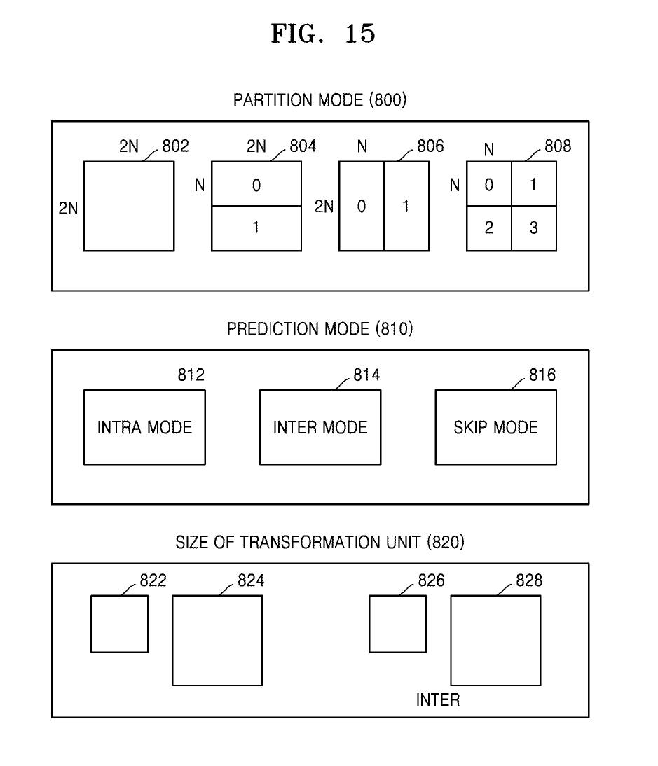

FIG. 15 illustrates a plurality of pieces of encoding information, according to various embodiments.

The output unit 130 of the video encoding apparatus 100 according to various embodiments may encode and transmit information 800 about a partition mode, information 810 about a prediction mode, and information 820 about a size of a transformation unit for each coding unit corresponding to a depth, as split information.

The information 800 indicates information about a shape of a partition obtained by splitting a prediction unit of a current coding unit, wherein the partition is a data unit for prediction encoding the current coding unit. For example, a current coding unit CU_0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about a partition type is set to indicate one of the partition 804 having a size of 2N×N, the partition 806 having a size of N×2N, and the partition 808 having a size of N×N.

The information 810 indicates a prediction mode of each partition. For example, the information 810 may indicate a mode of prediction encoding performed on a partition indicated by the information 800, i.e., an intra mode 812, an inter mode 814, or a skip mode 816.

The information 820 indicates a transformation unit to be based on when transformation is performed on a current coding unit. For example, the transformation unit may be a first intra transformation unit 822, a second intra transformation unit 824, a first inter transformation unit 826, or a second inter transformation unit 828.

The image data and encoding information extractor 220 of the video decoding apparatus 200 according to various embodiments may extract and use the information 800, 810, and 820 for decoding, according to each deeper coding unit.

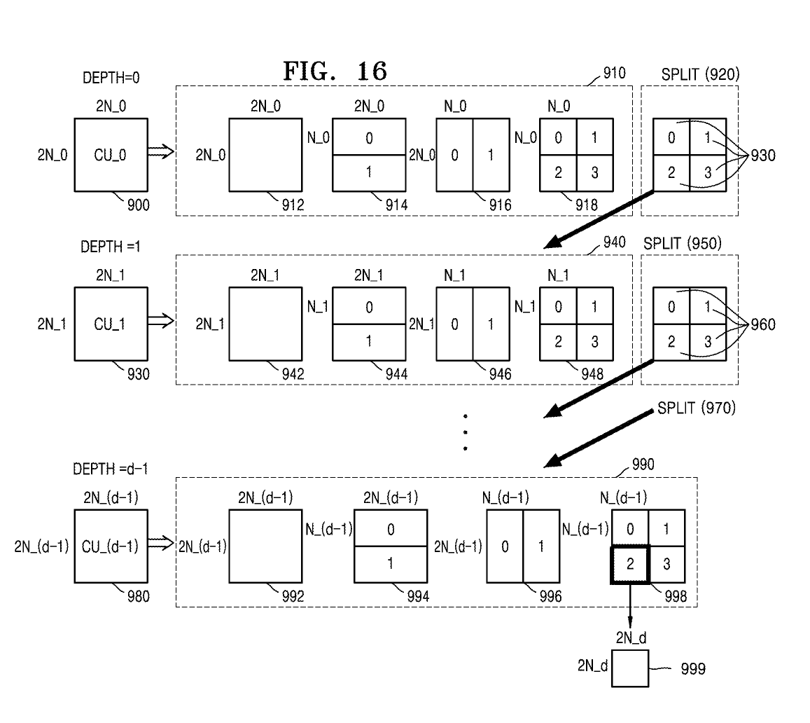

FIG. 16 is a diagram of deeper coding units according to depths, according to various embodiments.

Split information may be used to indicate a change of a depth. The spilt information indicates whether a coding unit of a current depth is split into coding units of a lower depth.

A prediction unit 910 for prediction encoding a coding unit 900 having a depth of 0 and a size of 2N_0×2N_0 may include partitions of a partition mode 912 having a size of 2N_0×2N_0, a partition mode 914 having a size of 2N_0×N_0, a partition mode 916 having a size of N_0×2N_0, and a partition mode 918 having a size of N_0×N_0. FIG. 16 only illustrates the partitions 912 through 918 which are obtained by symmetrically splitting the prediction unit, but a partition mode is not limited thereto, and the partitions of the prediction unit may include asymmetrical partitions, partitions having a predetermined shape, and partitions having a geometrical shape.

Prediction encoding is repeatedly performed on one partition having a size of 2N_0×2N_0, two partitions having a size of 2N_0×N_0, two partitions having a size of N_0×2N_0, and four partitions having a size of N_0×N_0, according to each partition mode. The prediction encoding in an intra mode and an inter mode may be performed on the partitions having the sizes of 2N_0×2N_0, N_0×2N_0, 2N_0×N_0, and N_0×N_0. The prediction encoding in a skip mode is performed only on the partition having the size of 2N_0×2N_0.

If an encoding error is smallest in one of the partition modes 912, 914, and 916, the prediction unit 910 may not be split into a lower depth.

If the encoding error is the smallest in the partition mode 918, a depth is changed from 0 to 1 to split the partition mode 918 in operation 920, and encoding is repeatedly performed on coding units 930 having a depth of 2 and a size of N_0×N_0 to search for a least encoding error.

A prediction unit 940 for prediction encoding the coding unit 930 having a depth of 1 and a size of 2N_1×2N_1 (=N_0×N_0) may include partitions of a partition mode 942 having a size of 2N_1×2N_1, a partition mode 944 having a size of 2N_1×N_1, a partition mode 946 having a size of N_1×2N_1, and a partition mode 948 having a size of N_1 xN_1.

If an encoding error is the smallest in the partition mode 948, a depth is changed from 1 to 2 to split the partition mode 948 in operation 950, and encoding is repeatedly performed on coding units 960, which have a depth of 2 and a size of N_2×N_2 to search for a least encoding error.

When a maximum depth is d, split operation according to each depth may be performed up to when a depth becomes d−1, and split information may be encoded as up to when a depth is one of 0 to d−2. That is, when encoding is performed up to when the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition mode 992 having a size of 2N_(d−1)×2N_(d−1), a partition mode 994 having a size of 2N_(d−1)×N_(d−1), a partition mode 996 having a size of N_(d−1)×2N_(d−1), and a partition mode 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition modes to search for a partition mode having a least encoding error.

Even when the partition mode 998 has the least encoding error, since a maximum depth is d, a coding unit CU_(d−1) having a depth of d−1 is no longer split to a lower depth, and a depth for the coding units constituting a current largest coding unit 900 is determined to be d−1 and a partition mode of the current largest coding unit 900 may be determined to be N_(d−1)×N_(d−1). Also, since the maximum depth is d, split information for a coding unit 952 having a depth of d−1 is not set.

A data unit 999 may be a ‘minimum unit’ for the current largest coding unit. A minimum unit according to various embodiments may be a square data unit obtained by splitting a smallest coding unit having a lowermost depth by 4. By performing the encoding repeatedly, the video encoding apparatus 100 according to various embodiments may select a depth having the least encoding error by comparing encoding errors according to depths of the coding unit 900 to determine a depth, and set a corresponding partition mode and a prediction mode as an encoding mode of the depth.

As such, the least encoding errors according to depths are compared in all of the depths of 1 through d, and a depth having the least encoding error may be determined as a d depth. The depth, the partition mode of the prediction unit, and the prediction mode may be encoded and transmitted as split information. Also, since a coding unit is split from a depth of 0 to a depth, only split information of the depth is set to 0, and split information of depths excluding the depth is set to 1.

The image data and encoding information extractor 220 of the video decoding apparatus 200 according to various embodiments may extract and use the information about the depth and the prediction unit of the coding unit 900 to decode the partition 912. The video decoding apparatus 200 according to various embodiments may determine a depth, in which split information is 0, as a depth by using split information according to depths, and use split information of the corresponding depth for decoding.

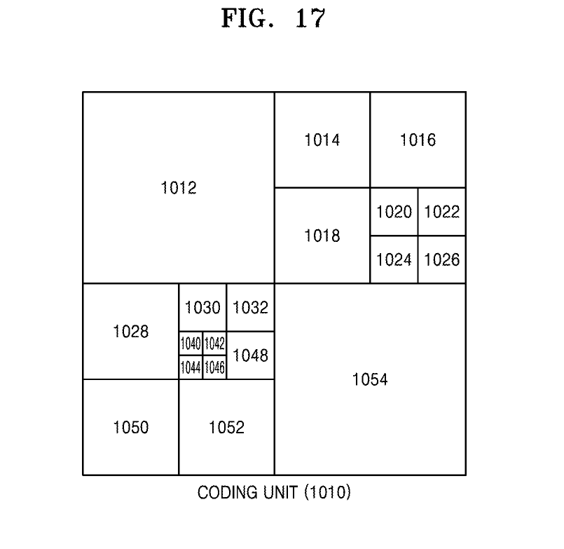

FIGS. 17, 18, and 19 are diagrams for describing a relationship between coding units, prediction units, and transformation units, according to various embodiments.

Coding units 1010 are coding units having a tree structure, according to depths determined by the video encoding apparatus 100 according to various embodiments, in a largest coding unit. Prediction units 1060 are partitions of prediction units of each of coding units according to depths, and transformation units 1070 are transformation units of each of coding units according to depths.

When a depth of a largest coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some coding units 1014, 1016, 1022, 1032, 1048, 1050, 1052, and 1054 are obtained by splitting the coding units in the coding units 1010. That is, partition modes in the coding units 1014, 1022, 1050, and 1054 have a size of 2N×N, partition modes in the coding units 1016, 1048, and 1052 have a size of N×2N, and a partition modes of the coding unit 1032 has a size of N×N. Prediction units and partitions of the coding units 1010 are smaller than or equal to each coding unit.

Transformation or inverse transformation is performed on image data of the coding unit 1052 in the transformation units 1070 in a data unit that is smaller than the coding unit 1052. Also, the coding units 1014, 1016, 1022, 1032, 1048, 1050, 1052, and 1054 in the transformation units 1070 are data units different from those in the prediction units 1060 in terms of sizes and shapes. That is, the video encoding and decoding apparatuses 100 and 200 according to various embodiments may perform intra prediction, motion estimation, motion compensation, transformation, and inverse transformation on an individual data unit in the same coding unit.

Accordingly, encoding is recursively performed on each of coding units having a hierarchical structure in each region of a largest coding unit to determine an optimum coding unit, and thus coding units having a recursive tree structure may be obtained. Encoding information may include split information about a coding unit, information about a partition mode, information about a prediction mode, and information about a size of a transformation unit. Table 1 shows the encoding information that may be set by the video encoding and decoding apparatuses 100 and 200 according to various embodiments.

TABLE 1

| Split Information 0 | | | | | Split |
|---|---|---|---|---|---|
| (Encoding on Coding unit having Size of 2N × 2N and Current Depth of d) | | | | | Information 1 |
| Prediction | Partition Type | | Size of Transform Unit | | Repeatedly |
| Mode | | | | | Encode |
| Intra | Symmetrical | Asymmetrical | Split | Split | Coding Units |
| Inter | Partition | Partition | Information 0 of | Information 1 of | having |
| Skip | Type | Type | Transform | Transform | Lower Depth |
| (Only | | | Unit | Unit | of d + 1 |
| 2N × 2N) | 2N × 2N | 2N × nU | 2N × 2N | N × N | |
| | 2N × N | 2N × nD | | (Symmetrical | |
| | N × 2N | nL × 2N | | Type) | |
| | N × N | nR × 2N | | N/2 × N/2 | |
| | | | | (Asymmetrical | |
| | | | | Type) | |

The output unit 130 of the video encoding apparatus 100 according to various embodiments may output the encoding information about the coding units having a tree structure, and the image data and encoding information extractor 220 of the video decoding apparatus 200 according to various embodiments may extract the encoding information about the coding units having a tree structure from a received bitstream.

Split information indicates whether a current coding unit is split into coding units of a lower depth. If split information of a current depth d is 0, a depth, in which a current coding unit is no longer split into a lower depth, is a depth, and thus information about a partition mode, prediction mode, and a size of a transformation unit may be defined for the depth. If the current coding unit is further split according to the split information, encoding is independently performed on four split coding units of a lower depth.

A prediction mode may be one of an intra mode, an inter mode, and a skip mode. The intra mode and the inter mode may be defined in all partition modes, and the skip mode is defined only in a partition mode having a size of 2N×2N.

The information about the partition mode may indicate symmetrical partition modes having sizes of 2N×2N, 2N×N, N×2N, and N×N, which are obtained by symmetrically splitting a height or a width of a prediction unit, and asymmetrical partition modes having sizes of 2N×nU, 2N×nD, nLx2N, and nRx2N, which are obtained by asymmetrically splitting the height or width of the prediction unit. The asymmetrical partition modes having the sizes of 2N×nU and 2N×nD may be respectively obtained by splitting the height of the prediction unit in 1:3 and 3:1, and the asymmetrical partition modes having the sizes of nLx2N and nRx2N may be respectively obtained by splitting the width of the prediction unit in 1:3 and 3:1.

The size of the transformation unit may be set to be two types in the intra mode and two types in the inter mode. In other words, if split information of the transformation unit is 0, the size of the transformation unit may be 2N×2N, which is the size of the current coding unit. If split information of the transformation unit is 1, the transformation units may be obtained by splitting the current coding unit. Also, if a partition mode of the current coding unit having the size of 2N×2N is a symmetrical partition mode, a size of a transformation unit may be N×N, and if the partition type of the current coding unit is an asymmetrical partition mode, the size of the transformation unit may be N/2×N/2.

The encoding information about coding units having a tree structure, according to various embodiments, may include at least one of a coding unit corresponding to a depth, a prediction unit, and a minimum unit. The coding unit corresponding to the depth may include at least one of a prediction unit and a minimum unit containing the same encoding information.

Accordingly, it is determined whether adjacent data units are included in the same coding unit corresponding to the depth by comparing encoding information of the adjacent data units. Also, a corresponding coding unit corresponding to a depth is determined by using encoding information of a data unit, and thus a distribution of depths in a largest coding unit may be determined.

Accordingly, if a current coding unit is predicted based on encoding information of adjacent data units, encoding information of data units in deeper coding units adjacent to the current coding unit may be directly referred to and used.

As another example, if a current coding unit is predicted based on encoding information of adjacent data units, data units adjacent to the current coding unit are searched using encoded information of the data units, and the searched adjacent coding units may be referred for predicting the current coding unit.

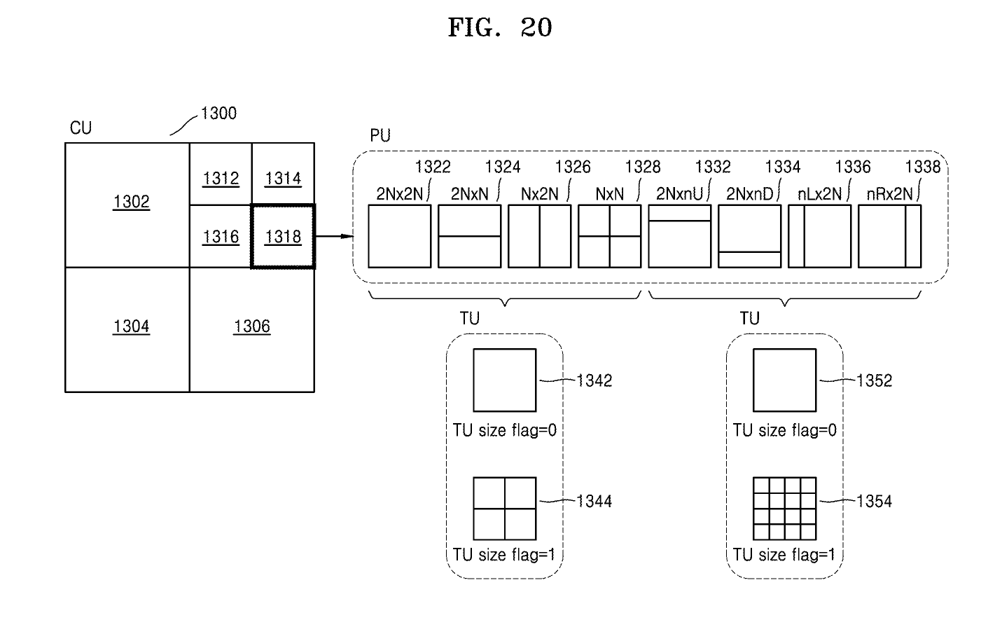

FIG. 20 is a diagram for describing a relationship between a coding unit, a prediction unit, and a transformation unit, according to encoding mode information of Table 1.

A largest coding unit 1300 includes coding units 1302, 1304, 1306, 1312, 1314, 1316, and 1318 of depths. Here, since the coding unit 1318 is a coding unit of a depth, split information may be set to 0. Information about a partition mode of the coding unit 1318 having a size of 2N×2N may be set to be one of a partition mode 1322 having a size of 2N×2N, a partition mode 1324 having a size of 2N×N, a partition mode 1326 having a size of N×2N, a partition mode 1328 having a size of N×N, a partition mode 1332 having a size of 2N×nU, a partition mode 1334 having a size of 2N×nD, a partition mode 1336 having a size of nLx2N, and a partition mode 1338 having a size of nRx2N.

Split information (TU size flag) of a transformation unit is a type of a transformation index. The size of the transformation unit corresponding to the transformation index may be changed according to a prediction unit type or partition mode of the coding unit.

For example, when the partition mode is set to be symmetrical, i.e. the partition mode 1322, 1324, 1326, or 1328, a transformation unit 1342 having a size of 2N×2N is set if a TU size flag of a transformation unit is 0, and a transformation unit 1344 having a size of N×N is set if a TU size flag is 1.

When the partition mode is set to be asymmetrical, i.e., the partition mode 1332, 1334, 1336, or 1338, a transformation unit 1352 having a size of 2N×2N is set if a TU size flag is 0, and a transformation unit 1354 having a size of N/2×N/2 is set if a TU size flag is 1.

Referring to FIG. 20, the TU size flag is a flag having a value or 0 or 1, but the TU size flag according to various embodiments is not limited to 1 bit, and a transformation unit may be hierarchically split having a tree structure while the TU size flag increases from 0. Split information (TU size flag) of a transformation unit may be an example of a transformation index.

In this case, the size of a transformation unit that has been actually used may be expressed by using a TU size flag of a transformation unit, according to various embodiments, together with a maximum size and minimum size of the transformation unit. The video encoding apparatus 100 according to various embodiments is capable of encoding maximum transformation unit size information, minimum transformation unit size information, and a maximum TU size flag. The result of encoding the maximum transformation unit size information, the minimum transformation unit size information, and the maximum TU size flag may be inserted into an SPS. The video decoding apparatus 200 according to various embodiments may decode video by using the maximum transformation unit size information, the minimum transformation unit size information, and the maximum TU size flag.

For example, (a) if the size of a current coding unit is 64×64 and a maximum transformation unit size is 32×32, (a−1) then the size of a transformation unit may be 32×32 when a TU size flag is 0, (a−2) may be 16×16 when the TU size flag is 1, and (a−3) may be 8×8 when the TU size flag is 2.

As another example, (b) if the size of the current coding unit is 32×32 and a minimum transformation unit size is 32×32, (b−1) then the size of the transformation unit may be 32×32 when the TU size flag is 0. Here, the TU size flag cannot be set to a value other than 0, since the size of the transformation unit cannot be less than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizeIndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit, may be defined by Equation (1):

CurrMinTuSize=max(MinTransformSize,RootTuSize/(2̂MaxTransformSizeIndex)) (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. In Equation (1), ‘RootTuSize/(2̂MaxTransformSizeIndex)’ denotes a transformation unit size when the transformation unit size ‘RootTuSize’, when the TU size flag is 0, is split a number of times corresponding to the maximum TU size flag, and ‘MinTransformSize’ denotes a minimum transformation size. Thus, a smaller value from among ‘RootTuSize/(2̂MaxTransformSizeIndex)’ and ‘MinTransformSize’ may be the current minimum transformation unit size ‘CurrMinTuSize’ that can be determined in the current coding unit.

According to various embodiments, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize,PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize,PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an example and the present disclosure is not limited thereto.

According to the video encoding method based on coding units having a tree structure as described with reference to FIGS. 8 through 20, image data of a spatial region is encoded for each coding unit of a tree structure. According to the video decoding method based on coding units having a tree structure, decoding is performed for each largest coding unit to reconstruct image data of a spatial region. Thus, a picture and a video that is a picture sequence may be reconstructed. The reconstructed video may be reproduced by a reproducing apparatus, stored in a storage medium, or transmitted through a network.

The embodiments according to the present disclosure may be written as computer programs and may be implemented in general-use digital computers that execute the programs using a computer-readable recording medium. Examples of the computer-readable recording medium include magnetic storage media (e.g., ROM, floppy discs, hard discs, etc.) and optical recording media (e.g., CD-ROMs, or DVDs).

For convenience of description, the inter-layer video encoding method and/or the video encoding method described above with reference to FIGS. 1A through 20 will be collectively referred to as a ‘video encoding method of the present disclosure’. In addition, the inter-layer video decoding method and/or the video decoding method described above with reference to FIGS. 1A through 20 will be referred to as a ‘video decoding method of the present disclosure’.

Also, a video encoding apparatus including the multi-layer video encoding apparatus 10, the video encoding apparatus 100, or the image encoder 400, which has been described with reference to FIGS. 1A through 20, will be referred to as a ‘video encoding apparatus of the present disclosure’. In addition, a video decoding apparatus including the multi-layer video decoding apparatus 20, the video decoding apparatus 200, or the image decoder 500, which has been descried with reference to FIGS. 1A through 20, will be collectively referred to as a ‘video decoding apparatus of the present disclosure’.

A computer-readable recording medium storing a program, e.g., a disc 26000, according to various embodiments will now be described in detail.

FIG. 21 is a diagram of a physical structure of the disc '26000 in which a program according to various embodiments is stored. The disc 26000, which is a storage medium, may be a hard drive, a compact disc-read only memory (CD-ROM) disc, a Blu-ray disc, or a digital versatile disc (DVD). The disc 26000 includes a plurality of concentric tracks Tr that are each divided into a specific number of sectors Se in a circumferential direction of the disc 26000. In a specific region of the disc 26000 according to the various embodiments, a program that executes the quantization parameter determining method, the video encoding method, and the video decoding method described above may be assigned and stored.

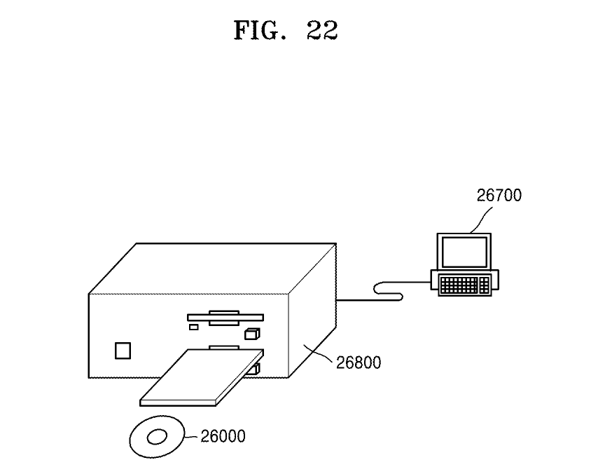

A computer system embodied using a storage medium that stores a program for executing the video encoding method and the video decoding method as described above will now be described with reference to FIG. 22.

FIG. 22 is a diagram of a disc drive 26800 for recording and reading a program by using the disc 26000. A computer system 27000 may store a program that executes at least one of a video encoding method and a video decoding method of the present disclosure, in the disc 26000 via the disc drive 26800. To run the program stored in the disc 26000 in the computer system 27000, the program may be read from the disc 26000 and be transmitted to the computer system 26700 by using the disc drive 27000.

The program that executes at least one of a video encoding method and a video decoding method of the present disclosure may be stored not only in the disc 26000 illustrated in FIG. 21 or 22 but also in a memory card, a ROM cassette, or a solid state drive (SSD).

A system to which the video encoding method and a video decoding method described above are applied will be described below.

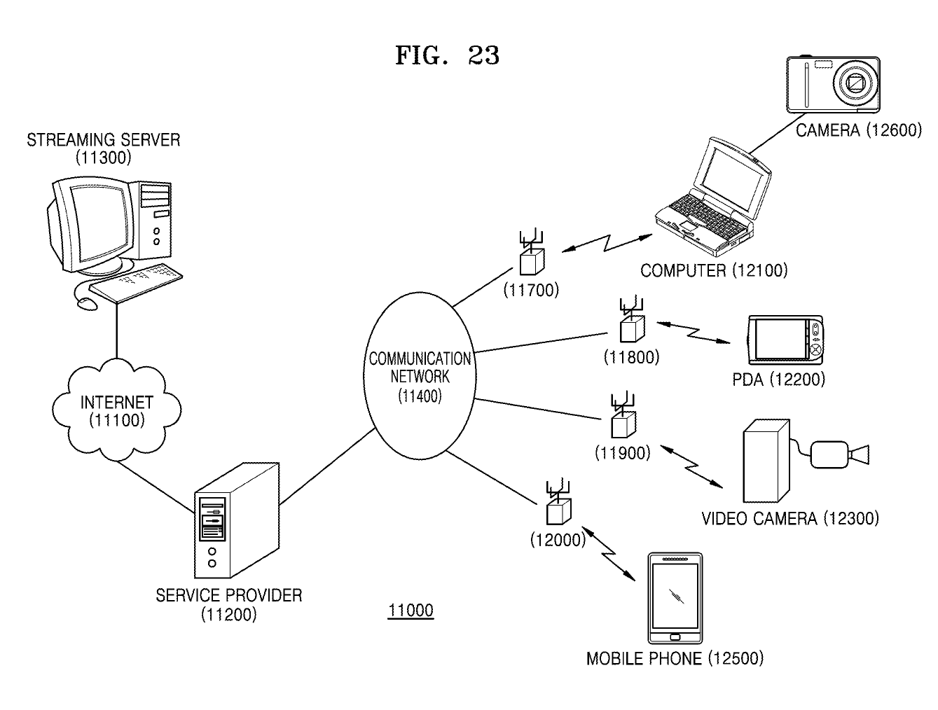

FIG. 23 is a diagram of an overall structure of a content supply system 11000 for providing a content distribution service. A service area of a communication system is divided into predetermined-sized cells, and wireless base stations 11700, 11800, 11900, and 12000 are installed in these cells, respectively.

The content supply system 11000 includes a plurality of independent devices. For example, the plurality of independent devices, such as a computer 12100, a personal digital assistant (PDA) 12200, a video camera 12300, and a mobile phone 12500, are connected to the Internet 11100 via an internet service provider 11200, a communication network 11400, and the wireless base stations 11700, 11800, 11900, and 12000.

However, the content supply system 11000 is not limited to the structure as illustrated in FIG. 23, and devices may be selectively connected thereto. The plurality of independent devices may be directly connected to the communication network 11400, not via the wireless base stations 11700, 11800, 11900, and 12000.

The video camera 12300 is an imaging device, e.g., a digital video camera, which is capable of capturing video images. The mobile phone 12500 may employ at least one communication method from among various protocols, e.g., Personal Digital Communications (PDC), Code Division Multiple Access (CDMA), Wideband-Code Division Multiple Access (W-CDMA), Global System for Mobile Communications (GSM), and Personal Handyphone System (PHS).

The video camera 12300 may be connected to a streaming server 11300 via the wireless base station 11900 and the communication network 11400. The streaming server 11300 allows content received from a user via the video camera 12300 to be streamed via a real-time broadcast. The content received from the video camera 12300 may be encoded by the video camera 12300 or the streaming server 11300. Video data captured by the video camera 12300 may be transmitted to the streaming server 11300 via the computer 12100.

Video data captured by a camera 12600 may also be transmitted to the streaming server 11300 via the computer 12100. The camera 12600 is an imaging device capable of capturing both still images and video images, similar to a digital camera. The video data captured by the camera 12600 may be encoded using the camera 12600 or the computer 12100. Software that performs encoding and decoding video may be stored in a computer-readable recording medium, e.g., a CD-ROM disc, a floppy disc, a hard disc drive, an SSD, or a memory card, which may be accessible by the computer 12100.

If video data is captured by a camera built in the mobile phone 12500, the video data may be received from the mobile phone 12500.

The video data may also be encoded by a large scale integrated circuit (LSI) system installed in the video camera 12300, the mobile phone 12500, or the camera 12600.

The content supply system 11000 according to various embodiments may encode content data recorded by a user using the video camera 12300, the camera 12600, the mobile phone 12500, or another imaging device, e.g., content recorded during a concert, and may transmit the encoded content data to the streaming server 11300. The streaming server 11300 may transmit the encoded content data in a type of a streaming content to other clients that request the content data.

The clients are devices capable of decoding the encoded content data, e.g., the computer 12100, the PDA 12200, the video camera 12300, or the mobile phone 12500. Thus, the content supply system 11000 allows the clients to receive and reproduce the encoded content data. Also, the content supply system 11000 allows the clients to receive the encoded content data and to decode and reproduce the encoded content data in real-time, thereby enabling personal broadcasting.

The video encoding apparatus and the video decoding apparatus of the present disclosure may be applied to encoding and decoding operations of the plurality of independent devices included in the content supply system 11000.

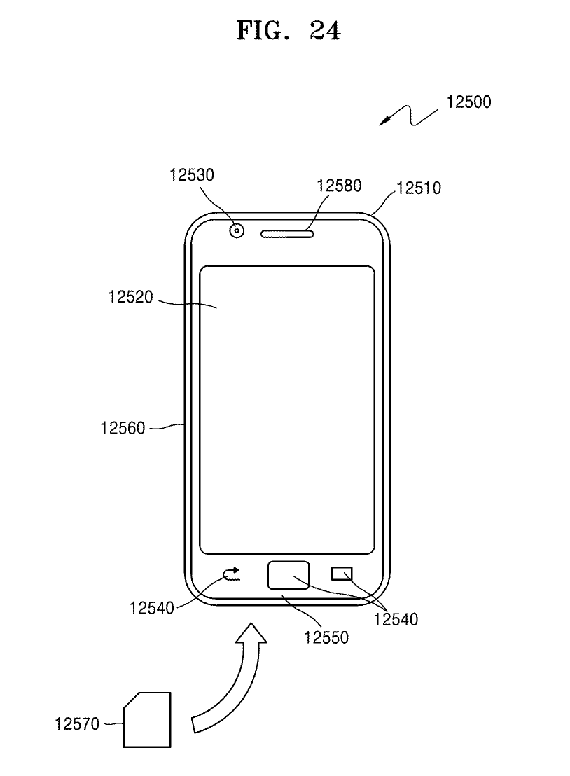

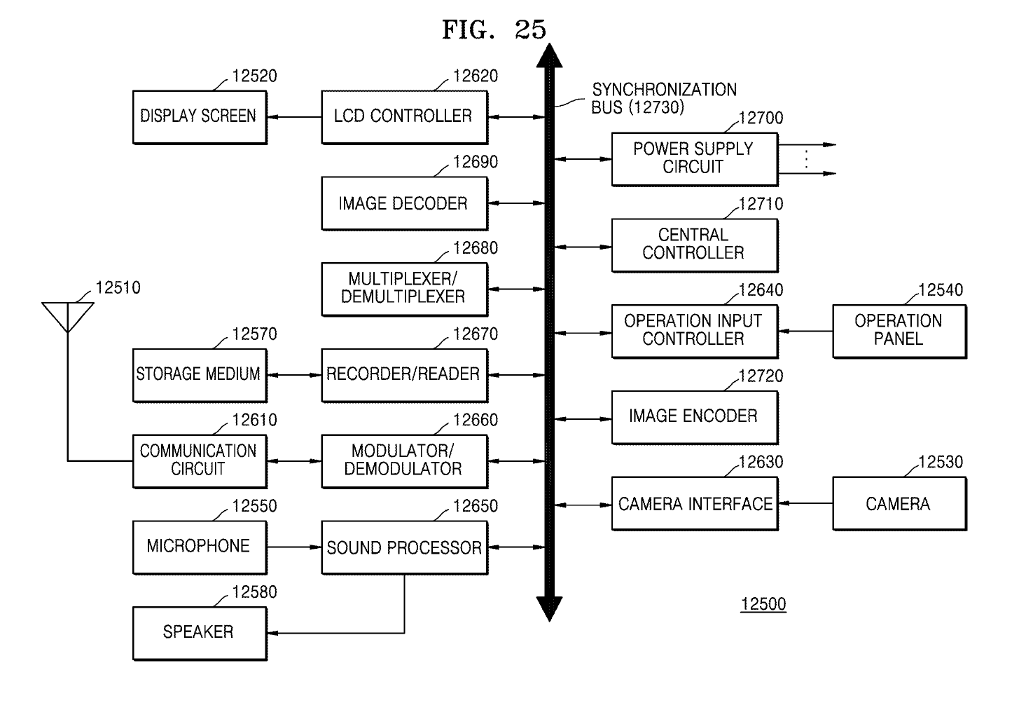

With reference to FIGS. 24 and 25, the mobile phone 12500 included in the content supply system 11000 according to an embodiment will now be described in greater detail.

FIG. 24 illustrates an external structure of the mobile phone 12500 to which the video encoding method and the video decoding method of the present disclosure are applied, according to various embodiments. The mobile phone 12500 may be a smart phone, the functions of which are not limited and a large number of the functions of which may be changed or expanded.

The mobile phone 12500 includes an internal antenna 12510 via which a radio-frequency (RF) signal may be exchanged with the wireless base station 12000 of FIG. 21, and includes a display screen 12520 for displaying images captured by a camera 12530 or images that are received via the antenna 12510 and decoded, e.g., a liquid crystal display (LCD) or an organic light-emitting diode (OLED) screen. The mobile phone 12500 includes an operation panel 12540 including a control button and a touch panel. If the display screen 12520 is a touch screen, the operation panel 12540 further includes a touch sensing panel of the display screen 12520. The mobile phone 12500 includes a speaker 12580 for outputting voice and sound or another type of sound output unit, and a microphone 12550 for inputting voice and sound or another type sound input unit. The mobile phone 12500 further includes the camera 12530, such as a charge-coupled device (CCD) camera, to capture video and still images. The mobile phone 12500 may further include a storage medium 12570 for storing encoded/decoded data, e.g., video or still images captured by the camera 12530, received via email, or obtained according to various ways; and a slot 12560 via which the storage medium 12570 is loaded into the mobile phone 12500. The storage medium 12570 may be a flash memory, e.g., a secure digital (SD) card or an electrically erasable and programmable read only memory (EEPROM) included in a plastic case.

FIG. 25 illustrates an internal structure of the mobile phone 12500. In order to systemically control parts of the mobile phone 12500 including the display screen 12520 and the operation panel 12540, a power supply circuit 12700, an operation input controller 12640, an image encoder 12720, a camera interface 12630, an LCD controller 12620, an image decoder 12690, a multiplexer/demultiplexer 12680, a recording/reading unit 12670, a modulation/demodulation unit 12660, and a sound processor 12650 are connected to a central controller 12710 via a synchronization bus 12730.

If a user operates a power button and sets from a ‘power off’ state to a ‘power on’ state, the power supply circuit 12700 supplies power to all the parts of the mobile phone 12500 from a battery pack, thereby setting the mobile phone 12500 in an operation mode.

The central controller 12710 includes a central processing unit (CPU), a ROM, and a RAM.

While the mobile phone 12500 transmits communication data to the outside, a digital signal is generated by the mobile phone 12500 under control of the central controller 12710. For example, the sound processor 12650 may generate a digital sound signal, the image encoder 12720 may generate a digital image signal, and text data of a message may be generated via the operation panel 12540 and the operation input controller 12640. When a digital signal is transmitted to the modulation/demodulation unit 12660 under control of the central controller 12710, the modulation/demodulation unit 12660 modulates a frequency band of the digital signal, and a communication circuit 12610 performs digital-to-analog conversion (DAC) and frequency conversion on the frequency band-modulated digital sound signal. A transmission signal output from the communication circuit 12610 may be transmitted to a voice communication base station or the wireless base station 12000 via the antenna 12510.

For example, when the mobile phone 12500 is in a conversation mode, a sound signal obtained via the microphone 12550 is transformed into a digital sound signal by the sound processor 12650, under control of the central controller 12710. The digital sound signal may be transformed into a transformation signal via the modulation/demodulation unit 12660 and the communication circuit 12610, and may be transmitted via the antenna 12510.

When a text message, e.g., email, is transmitted in a data communication mode, text data of the text message is input via the operation panel 12540 and is transmitted to the central controller 12610 via the operation input controller 12640. Under control of the central controller 12610, the text data is transformed into a transmission signal via the modulation/demodulation unit 12660 and the communication circuit 12610 and is transmitted to the wireless base station 12000 via the antenna 12510.

In order to transmit image data in the data communication mode, image data captured by the camera 12530 is provided to the image encoder 12720 via the camera interface 12630. The captured image data may be directly displayed on the display screen 12520 via the camera interface 12630 and the LCD controller 12620.

A structure of the image encoder 12720 may correspond to that of the video encoding apparatus 100 described above. The image encoder 12720 may transform the image data received from the camera 12530 into compressed and encoded image data according to the video encoding method described above, and then output the encoded image data to the multiplexer/demultiplexer 12680. During a recording operation of the camera 12530, a sound signal obtained by the microphone 12550 of the mobile phone 12500 may be transformed into digital sound data via the sound processor 12650, and the digital sound data may be transmitted to the multiplexer/demultiplexer 12680.

The multiplexer/demultiplexer 12680 multiplexes the encoded image data received from the image encoder 12720, together with the sound data received from the sound processor 12650. A result of multiplexing the data may be transformed into a transmission signal via the modulation/demodulation unit 12660 and the communication circuit 12610, and may then be transmitted via the antenna 12510.

While the mobile phone 12500 receives communication data from an external source, frequency recovery and ADC are performed on a signal received via the antenna 12510 to transform the signal into a digital signal. The modulation/demodulation unit 12660 modulates a frequency band of the digital signal. The frequency-band modulated digital signal is transmitted to the video decoding unit 12690, the sound processor 12650, or the LCD controller 12620, according to the type of the digital signal.

In the conversation mode, the mobile phone 12500 amplifies a signal received via the antenna 12510, and obtains a digital sound signal by performing frequency conversion and ADC on the amplified signal. A received digital sound signal is transformed into an analog sound signal via the modulation/demodulation unit 12660 and the sound processor 12650, and the analog sound signal is output via the speaker 12580, under control of the central controller 12710.

When in the data communication mode, data of a video file accessed at an Internet website is received, a signal received from the wireless base station 12000 via the antenna 12510 is output as multiplexed data via the modulation/demodulation unit 12660, and the multiplexed data is transmitted to the multiplexer/demultiplexer 12680.

In order to decode the multiplexed data received via the antenna 12510, the multiplexer/demultiplexer 12680 demultiplexes the multiplexed data into an encoded video data stream and an encoded audio data stream. Via the synchronization bus 12730, the encoded video data stream and the encoded audio data stream are provided to the video decoding unit 12690 and the sound processor 12650, respectively.

A structure of the image decoder 12690 may correspond to that of the video decoding apparatus 200 described above. The image decoder 12690 may decode the encoded video data to obtain reconstructed video data and provide the reconstructed video data to the display screen 12520 via the LCD controller 12620, according to a video decoding method employed by the video decoding apparatus 200 or the image decoder 500 described above.

Thus, the data of the video file accessed at the Internet website may be displayed on the display screen 12520. At the same time, the sound processor 12650 may transform audio data into an analog sound signal, and provide the analog sound signal to the speaker 12580. Thus, audio data contained in the video file accessed at the Internet website may also be reproduced via the speaker 12580.

The mobile phone 12500 or another type of communication terminal may be a transceiving terminal including both the video encoding apparatus and the video decoding apparatus of the present disclosure, may be a transceiving terminal including only the video encoding apparatus of the present disclosure, or may be a transceiving terminal including only the video decoding apparatus of the present disclosure.

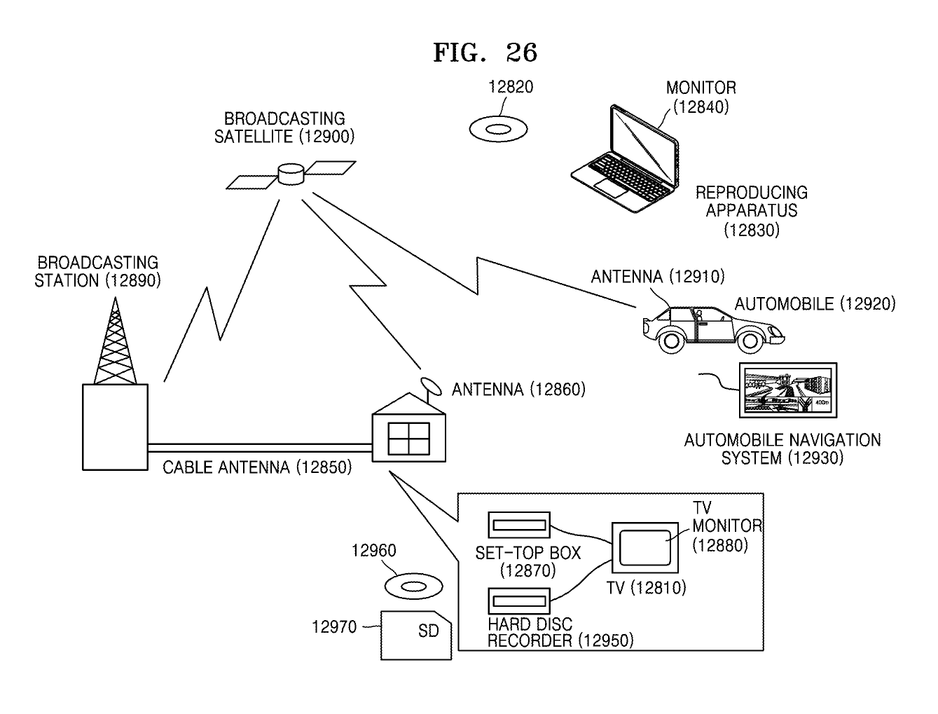

A communication system according to the present disclosure is not limited to the communication system described above with reference to FIG. 23. For example, FIG. 26 illustrates a digital broadcasting system employing a communication system, according to various embodiments. The digital broadcasting system of FIG. 26 according to various embodiments may receive a digital broadcast transmitted via a satellite or a terrestrial network by using the video encoding apparatus and the video decoding apparatus of the present disclosure.

In more detail, a broadcasting station 12890 transmits a video data stream to a communication satellite or a broadcasting satellite 12900 by using radio waves. The broadcasting satellite 12900 transmits a broadcast signal, and the broadcast signal is transmitted to a satellite broadcast receiver via a household antenna 12860. In every house, an encoded video stream may be decoded and reproduced by a TV receiver 12810, a set-top box 12870, or another device.

When the video decoding apparatus of the present disclosure is implemented in a reproducing apparatus 12830, the reproducing apparatus 12830 may parse and decode an encoded video stream recorded on a storage medium 12820, such as a disc or a memory card to reconstruct digital signals. Thus, the reconstructed video signal may be reproduced, for example, on a monitor 12840.

In the set-top box 12870 connected to the antenna 12860 for a satellite/terrestrial broadcast or a cable antenna 12850 for receiving a cable television (TV) broadcast, the video decoding apparatus of the present disclosure may be installed. Data output from the set-top box 12870 may also be reproduced on a TV monitor 12880.

As another example, the video decoding apparatus of the present disclosure may be installed in the TV receiver 12810 instead of the set-top box 12870.

An automobile 12920 that has an appropriate antenna 12910 may receive a signal transmitted from the satellite 12900 or the wireless base station 11700. A decoded video may be reproduced on a display screen of an automobile navigation system 12930 installed in the automobile 12920.

A video signal may be encoded by the video encoding apparatus of the present disclosure and may then be recorded to and stored in a storage medium. In more detail, an image signal may be stored in a DVD disc 12960 by a DVD recorder or may be stored in a hard disc by a hard disc recorder 12950. As another example, the video signal may be stored in an SD card 12970. If the hard disc recorder 12950 includes the video decoding apparatus of the present disclosure according to various embodiments, a video signal recorded on the DVD disc 12960, the SD card 12970, or another storage medium may be reproduced on the TV monitor 12880.

The automobile navigation system 12930 may not include the camera 12530, the camera interface 12630, and the image encoder 12720 of FIG. 26. For example, the computer 12100 and the TV receiver 12810 may not include the camera 12530, the camera interface 12630, and the image encoder 12720 of FIG. 26.

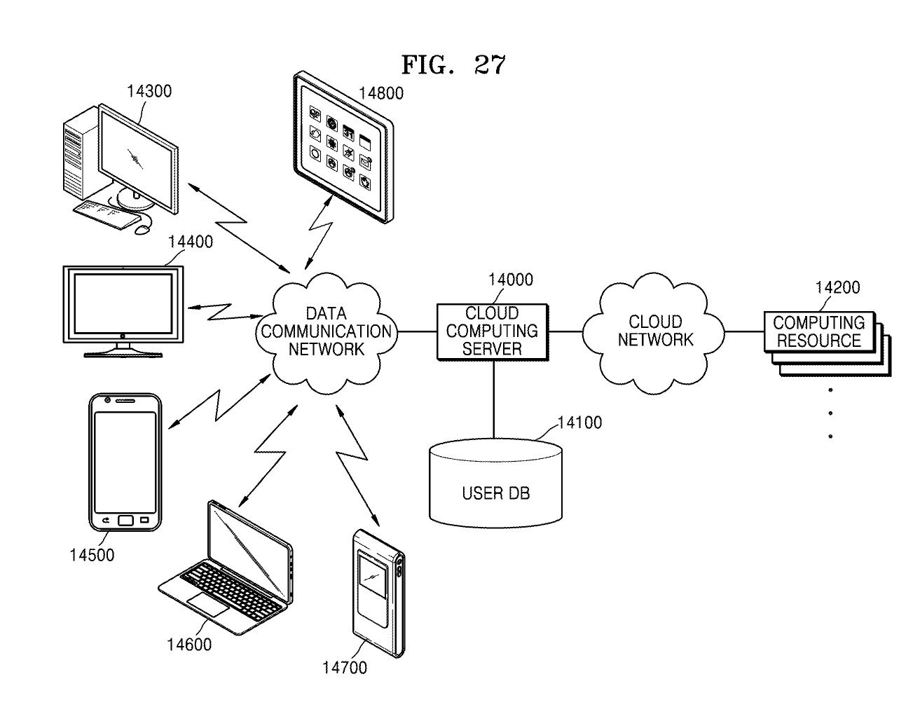

FIG. 27 is a diagram illustrating a network structure of a cloud computing system using a video encoding apparatus and a video decoding apparatus, according to various embodiments.

The cloud computing system may include a cloud computing server 14000, a user database (DB) 14100, a plurality of computing resources 14200, and a user terminal.

The cloud computing system provides an on-demand outsourcing service of the plurality of computing resources 14200 via a data communication network, e.g., the Internet, in response to a request from the user terminal. Under a cloud computing environment, a service provider provides users with desired services by combining computing resources at data centers located at physically different locations by using virtualization technology. A service user does not have to install computing resources, e.g., an application, a storage, an operating system (OS), and security, into his/her own terminal in order to use them, but may select and use desired services from among services in a virtual space generated through the virtualization technology, at a desired point in time.

A user terminal of a specified service user is connected to the cloud computing server 14000 via a data communication network including the Internet and a mobile telecommunication network. User terminals may be provided cloud computing services, and particularly video reproduction services, from the cloud computing server 14000. The user terminals may be various types of electronic devices capable of being connected to the Internet, e.g., a desktop PC 14300, a smart TV 14400, a smart phone 14500, a notebook computer 14600, a portable multimedia player (PMP) 14700, a tablet PC 14800, and the like.

The cloud computing server 14000 may combine the plurality of computing resources 14200 distributed in a cloud network and provide user terminals with a result of combining. The plurality of computing resources 14200 may include various data services, and may include data uploaded from user terminals. As described above, the cloud computing server 14000 may provide user terminals with desired services by combining video database distributed in different regions according to the virtualization technology.

User information about users who have subscribed for a cloud computing service is stored in the user DB 14100. The user information may include logging information, addresses, names, and personal credit information of the users. The user information may further include indexes of videos. Here, the indexes may include a list of videos that have already been reproduced, a list of videos that are being reproduced, a pausing point of a video that was being reproduced, and the like.

Information about a video stored in the user DB 14100 may be shared between user devices. For example, when a video service is provided to the notebook computer 14600 in response to a request from the notebook computer 14600, a reproduction history of the video service is stored in the user DB 14100. When a request to reproduce this video service is received from the smart phone 14500, the cloud computing server 14000 searches for and reproduces this video service, based on the user DB 14100. When the smart phone 14500 receives a video data stream from the cloud computing server 14000, a process of reproducing video by decoding the video data stream is similar to an operation of the mobile phone 12500 described above with reference to FIG. 24.

The cloud computing server 14000 may refer to a reproduction history of a desired video service, stored in the user DB 14100. For example, the cloud computing server 14000 receives a request to reproduce a video stored in the user DB 14100, from a user terminal. If this video was being reproduced, then a method of streaming this video, performed by the cloud computing server 14000, may vary according to the request from the user terminal, i.e., according to whether the video will be reproduced, starting from a start thereof or a pausing point thereof. For example, if the user terminal requests to reproduce the video, starting from the start thereof, the cloud computing server 14000 transmits streaming data of the video starting from a first frame thereof to the user terminal. On the other hand, if the user terminal requests to reproduce the video, starting from the pausing point thereof, the cloud computing server 14000 transmits streaming data of the video starting from a frame corresponding to the pausing point, to the user terminal.

In this case, the user terminal may include the video decoding apparatus of the present disclosure as described above with reference to FIGS. 1A through 20. As another example, the user terminal may include the video encoding apparatus of the present disclosure as described above with reference to FIGS. 1A through 20. Alternatively, the user terminal may include both the video decoding apparatus and the video encoding apparatus of the present disclosure as described above with reference to FIGS. 1A through 20.

Various applications of a video encoding method, a video decoding method, a video encoding apparatus, and a video decoding apparatus according to various embodiments described above with reference to FIGS. 1A through 20 have been described above with reference to FIGS. 21 through 27. However, methods of storing the video encoding method and the video decoding method in a storage medium or methods of implementing the video encoding apparatus and the video decoding apparatus in a device, according to various embodiments, are not limited to the embodiments described above with reference to FIGS. 21 through 27.

It will be understood by one of ordinary skill in the art that various changes in form and details may be made therein without departing from the spirit and scope of the disclosure as defined by the appended claims. The embodiments should be considered in a descriptive sense only and not for purposes of limitation. Therefore, the scope of the disclosure is defined not by the detailed description of the disclosure but by the appended claims, and all differences within the scope will be construed as being included in the present disclosure.

1. A multi-layer video decoding method comprising:
determining a depth block corresponding to a current block;
splitting the current block into two regions, based on sample values comprised in the determined depth block; and
performing motion compensation by using the split two regions.

2. The multi-layer video decoding method of claim 1, wherein the splitting of the current block into the two regions, based on the sample values comprised in the determined depth block comprises:
determining an average value of corner pixels of the depth block as a threshold value;
splitting the depth block into a first region and a second region, wherein the first region comprises samples of which sample values are each greater than the threshold value and the second region comprises samples of which sample values are each equal to or less than the threshold value; and
splitting the current block, based on split shapes of the first region and the second region.

3. The multi-layer video decoding method of claim 1, further comprising:
determining a partition mode of the current block as one of a PART_2N×N mode and a PART_N×2N mode; and
determining motion vectors with respect to partitions of the current block, respectively, based on the determined partition mode of the current block.

4. The multi-layer video decoding method of claim 2, wherein the corner pixels comprise one or more of a top-left pixel, a bottom-left pixel, a top-right pixel, and a bottom-right pixel in the depth block.

5. The multi-layer video decoding method of claim 3, wherein the motion vectors are determined based on motion vectors used in the motion compensation.

6. A multi-layer video encoding method comprising:
determining a depth block corresponding to a current block;
splitting the current block into two regions, based on sample values comprised in the determined depth block; and
performing motion compensation by using the split two regions.

7. The multi-layer video encoding method of claim 6, wherein the splitting of the current block into the two regions, based on the sample values comprised in the determined depth block, comprises:
determining an average value of corner pixels of the depth block as a threshold value;
splitting the depth block into a first region and a second region, wherein the first region comprises samples of which sample values are each greater than the threshold value and the second region comprises samples of which sample values are each equal to or less than the threshold value; and
splitting the current block, based on split shapes of the first region and the second region.

8. The multi-layer video encoding method of claim 6, further comprising:
determining a partition mode of the current block as one of a predetermined number of partition modes, based on the sample values comprised in the determined depth block; and
determining motion vectors with respect to partitions of the current block, based on the determined partition mode of the current block,
wherein the motion vectors are determined based on motion vectors used in the motion compensation.

9. The multi-layer video encoding method of claim 7, wherein the corner pixels comprise one or more of a top-left pixel, a bottom-left pixel, a top-right pixel, and a bottom-right pixel in the depth block.

10. The multi-layer video encoding method of claim 8, wherein the predetermined number of partition modes comprises two partition modes that are a PART_N×2N mode and a PART_2N×N mode.

11. A multi-layer video decoding apparatus comprising a decoder configured to:
determine a depth block corresponding to a current block,
split the current block into two regions, based on sample values comprised in the determined depth block, and
perform motion compensation by using the split two regions.

12. The multi-layer video decoding apparatus of claim 11, wherein the decoder is further configured to:
determine an average value of corner pixels of the depth block as a threshold value,
split the depth block into a first region and a second region, wherein the first region comprises samples of which sample values are each greater than the threshold value and the second region comprises samples of which sample values are each equal to or less than the threshold value; and
split the current block, based on split shapes of the first region and the second region.

13-15. (canceled)
